(19) United States
(12) Patent Application Publication
(10) Pub. No.: US 2017/0289074 A1
(43) Pub. Date: Oct. 5, 2017

(54) METHOD FOR MESSENGER OPERATION BASED ON LOCATION INFORMATION AND ELECTRONIC DEVICE SUPPORTING THE SAME

(71) Applicant: Samsung Electronics Co., Ltd, Gyeonggi-do (KR)

(72) Inventors: Jaeseok Joo, Seoul (KR); Jeongmin Park, Gyeonggi-do (KR); Taeho Kim, Chungcheongbuk-do (KR)

(21) Appl. No.: 15/473,531

(22) Filed: Mar. 29, 2017

(30) Foreign Application Priority Data
Mar. 29, 2016 (KR) 10-2016-0037927

(51) Int. Cl. H04L 12/58; H04W 4/02; H04L 29/08

(52) U.S. Cl. CPC H04L 51/04; H04L 67/18; H04W 4/021

(57) ABSTRACT

A method for messenger operation based on location information of an electronic device is disclosed. The method may include: creating a chat room with two or more members on the basis of geofence information, monitoring whether a chatroom member enters or exits the geofence, displaying a message input window for the chat room, determining whether all the chatroom members remain in the geofence, and sending, when all chatroom members remain in the geofence, a message to electronic devices of the chatroom members in response to a message transmission request.

### CROSS-REFERENCE TO RELATED APPLICATION(S) AND CLAIM OF PRIORITY

The present application is related to and claims the benefit under 35 U. S.C. §119(a) of a Korean patent application filed on Mar. 29, 2016, in the Korean Intellectual Property Office and assigned Serial No. 10-2016-0037927, the entire disclosure of which is hereby incorporated by reference.

### TECHNICAL FIELD

Various embodiments of the present disclosure relate to a method for messenger operation using geofencing based on location information and an electronic device supporting the same.

### BACKGROUND

Recent advances in digital technologies have enabled development of various types of electronic devices that enable users on the move to process personal information, such as mobile communication terminals, personal digital assistants (PDA), electronic schedulers, smartphones, and tablet personal computers. Electronic devices have evolved into mobile convergence devices supporting heterogeneous functions having originated from distinct fields. For example, such an electronic device may support various functions related to voice or video calls, text or multimedia messages, electronic organizers, image capture, broadcast reception, video playback, music playback, Internet access, instant messaging, and social networking services (SNS).

Meanwhile, when an electronic device supports instant messaging, the user of the electronic device may create a chat room with one or more members and the electronic device may maintain the chat room.

While the chat room is maintained after creation, the electronic device may notify the user of message reception and deliver the received message to the user regardless of the location of the electronic device. Hence, the user can be inconvenienced by having to receive a message unfit for the purpose of the chat room.

### SUMMARY

To address the above-discussed deficiencies, it is a primary object to provide an electronic device that can support the messenger function through geo-fencing based on location information.

In accordance with an aspect of the present disclosure, there is provided a method for messenger operation based on location information of an electronic device. The method may include: creating a chat room with two or more members on the basis of geofence information; monitoring whether a chatroom member enters or exits the geofence; displaying a message input window for the chat room; determining whether all the chatroom members remain in the geofence; and sending, when all chatroom members remain in the geofence, a message to electronic devices of the chatroom members in response to a message transmission request.

In accordance with another aspect of the present disclosure, there is provided an electronic device. The electronic device may include: a location measurement sensor; a communication module; a display having a touch panel; and a processor. The processor may create a chat room with two or more members on the basis of geofence information, monitor whether a chatroom member enters or exits the geofence, control the display to display a message input window for the chat room, determine whether all the chatroom members remain in the geofence, and control, when all chatroom members remain in the geofence, the communication module to send a message to electronic devices of the chatroom members in response to a message transmission request.

In a feature of the present disclosure, the messenger operation method using geo-fencing enables the electronic device to perform the messenger function on the basis of location information. Hence, when a chat room is created in connection with a specific geographic area, it is possible to process messages depending upon whether the user remains in the geofence.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including electronic devices according to various embodiments of the present disclosure.

FIG. 2 illustrates a block diagram of an electronic device according to various embodiments of the present disclosure.

FIG. 3 illustrates a block diagram of a program module according to various embodiments of the present disclosure.

FIG. 4 illustrates a flowchart of a procedure for handling messages based on location information of the electronic device according to various embodiments of the present disclosure.

FIG. 5 illustrates creation of a chat room based on geofence information of the electronic device according to various embodiments of the present disclosure.

FIGS. 6 to 9 illustrate configuration of a geofence according to various embodiments of the present disclosure.

FIG. 10 illustrates screen representations for configuring a geofence according to various embodiments of the present disclosure.

FIGS. 11 and 12 illustrate transmission of messages according to various embodiments of the present disclosure.

FIG. 13 illustrates a sequence diagram depicting signal flows between the server and electronic devices for geofence-based messenger operation according to various embodiments of the present disclosure.

FIG. 14 illustrates a sequence diagram depicting signal flows between the server and electronic devices for geofence-based messenger operation according to various embodiments of the present disclosure.

FIG. 15 illustrates a sequence diagram depicting signal flows between the server and electronic devices for geofence-based messenger operation according to various embodiments of the present disclosure.

FIGS. 16 and 17 illustrate configuration of a geofence according to various embodiments of the present disclosure.

FIG. 18 illustrates a flowchart of a procedure for messenger operation based on location information of the electronic device according to various embodiments of the present disclosure.

FIG. 19 illustrates messenger operation based on location information of the electronic device according to various embodiments of the present disclosure.

FIG. 20 illustrates a flowchart of a procedure for messenger operation based on location information of the electronic device according to various embodiments of the present disclosure.

FIG. 21 illustrates messenger operation based on location information of the electronic device according to various embodiments of the present disclosure.

FIG. 22 illustrates a flowchart of a procedure for messenger operation based on location information of the electronic device according to various embodiments of the present disclosure.

FIG. 23 illustrates messenger operation based on location information of the electronic device according to various embodiments of the present disclosure.

FIG. 24 illustrates a flowchart of a procedure for messenger operation based on location information of the electronic device according to various embodiments of the present disclosure.

FIG. 25 illustrates a sequence diagram depicting signal flows between the server and electronic devices for messenger operation based on location information according to various embodiments of the present disclosure.

FIG. 26 illustrates a user interface window of a schedule application according to various embodiments of the present disclosure.

FIG. 27 illustrates monitoring of a chatroom creation condition on the basis of schedule information according to various embodiments of the present disclosure.

FIG. 28 illustrates screen representations for messenger operation based on location information according to various embodiments of the present disclosure.

FIG. 29 illustrates a flowchart of a procedure for messenger operation based on location information of the electronic device according to various embodiments of the present disclosure.

### DETAILED DESCRIPTION

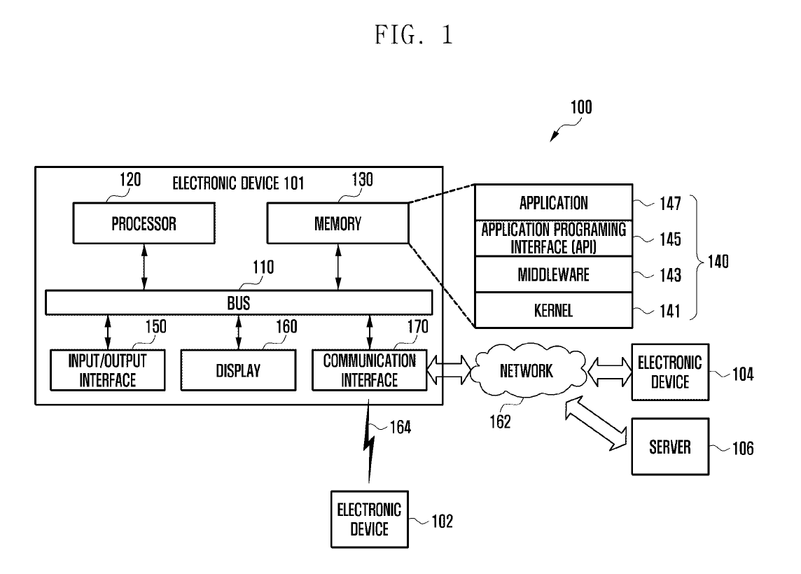

FIGS. 1 through 29, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, the present disclosure will be described with reference to the accompanying drawings. Although specific embodiments are illustrated in the drawings and related detailed descriptions are discussed in the present specification, the present disclosure may have various modifications and several embodiments. However, various embodiments of the present disclosure are not limited to a specific implementation form and it should be understood that the present disclosure includes all changes and/or equivalents and substitutes included in the spirit and scope of various embodiments of the present disclosure. In connection with descriptions of the drawings, similar components are designated by the same reference numeral.

The term “include” or “may include” which may be used in describing various embodiments of the present disclosure refers to the existence of a corresponding disclosed function, operation or component which can be used in various embodiments of the present disclosure and does not limit one or more additional functions, operations, or components. In various embodiments of the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component is “coupled to” or “connected to” another component, the component may be directly coupled or connected to another component or a new component may exist between the component and another component. In contrast, when it is stated that a component is “directly coupled to” or “directly connected to” another component, a new component does not exist between the component and another component.

The terms used in describing various embodiments of the present disclosure are only examples for describing a specific embodiment but do not limit the various embodiments of the present disclosure. Singular forms are intended to include plural forms unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present description.

An electronic device according to various embodiments of the present disclosure may be a device including a communication function. For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HIVID) such as electronic glasses, electronic clothes, and electronic bracelet, an electronic necklace, an electronic appcessary, an electronic tattoo, and a smart watch.

According to some embodiments, the electronic device may be a smart home appliance having a communication function. The smart home appliance may include at least one of a TeleVision (TV), a Digital Video Disk (DVD) player, an audio player, an air conditioner, a cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame.

According to some embodiments, the electronic device may include at least one of various types of medical devices (for example, Magnetic Resonance Angiography (MRA), Magnetic Resonance Imaging (MRI), Computed Tomography (CT), a scanner, an ultrasonic device and the like), a navigation device, a Global Navigation Satellite System (GNSS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM) of financial institutions, and a Point Of Sale (POS) device of shops.

According to some embodiments, the electronic device may include at least one of furniture or a part of a building/structure, an electronic board, an electronic signature receiving device, a projector, and various types of measuring devices (for example, a water meter, an electricity meter, a gas meter, a radio wave meter and the like) including a camera function. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices.

Hereinafter, an electronic device according to various embodiments of the present disclosure will be described with reference to the accompanying drawings. The term “user” used in various embodiments may refer to a person who uses an electronic device or a device (for example, an artificial intelligence electronic device) which uses an electronic device.

According to one embodiment of the present disclosure, a screen of an electronic device may be split into at least two windows according to a predefined split manner and displayed through a display of an electronic device. The windows are defined as split windows. According to one embodiment, the split windows are defined as windows displayed on a display of an electronic display not to be superposed one on another.

According to one embodiment, a popup window is defined as a window displayed on a display of an electronic device to hide or to be superposed on a portion of a screen under execution.

According to one embodiment of the present disclosure, an electronic device using split window and a popup window is capable of displaying two or more application execution screens or function execution screens. Thus, the split windows and the popup window are defined as a multi-window.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

FIG. 1 illustrates a network environment 10 including an electronic device 101 according to various embodiments of the present disclosure. Referring to FIG. 1, the electronic device 100 includes a bus 110, a processor 120, a memory 130, a input/output interface 150, a display 160 and a communication interface 170.

The bus 110 may be a circuit connecting the above described components and transmitting communication (for example, a control message) between the above described components. The processor 120 receives commands from other components (for example, the memory 130, the input/output interface 150, the display 160, the communication interface 170) through the bus 110, analyzes the received commands, and executes calculation or data processing according to the analyzed commands. The memory 130 stores commands or data received from the processor 120 or other components (for example, the input/output interface 150, the display 160, or the communication interface 170) or generated by the processor 120 or other components. The memory 130 may include programming modules 140, for example, a kernel 141, middleware 143, an Application Programming Interface (API) 145, and an application 147. Each of the aforementioned programming modules may be implemented by software, firmware, hardware, or a combination of two or more thereof. The kernel 141 controls or manages system resources (for example, the bus 110, the processor 120, or the memory 130) used for executing an operation or function implemented by the remaining other programming modules, for example, the middleware 143, the API 145, or the application 147. Further, the kernel 141 provides an interface for accessing individual components of the electronic device 101 from the middleware 143, the API 145, or the application 147 to control or manage the components. The middleware 143 performs a relay function of allowing the API 145 or the application 147 to communicate with the kernel 141 to exchange data. Further, in operation requests received from the application 147, the middleware 143 performs a control for the operation requests (for example, scheduling or load balancing) by using a method of assigning a priority, by which system resources (for example, the bus 110, the processor 120, the memory 130 and the like) of the electronic device 100 can be used, to the application 134.

The API 145 is an interface by which the application 147 can control a function provided by the kernel 141 or the middleware 143 and includes, for example, at least one interface or function (for example, command) for a file control, a window control, image processing, or a character control. The input/output interface 150 can receive, for example, a command and/or data from a user, and transfer the received command and/or data to the processor 120 and/or the memory 130 through the bus 110. The display 160 can display an image, a video, and/or data to a user.

According to an embodiment, the display 160 may display a graphic user interface image for interaction between the user and the electronic device 100. According to various embodiments, the graphic user interface image may include interface information to activate a function for correcting color of the image to be projected onto the screen. The interface information may be in the form of, for example, a button, a menu, or an icon. The communication interface 170 connects communication between the electronic device 100 and the external device (for example, electronic device 102, 104 or server 106). For example, the communication interface 170 may access a network 162 through wireless or wired communication to communicate with the external device. The wireless communication includes at least one of, for example, Wi-Fi®, BlueTooth® (BT), Near Field Communication (NFC), a Global Navigation Satellite System (GNSS), and cellular communication (for example, LTE, LTE-A, CDMA, WCDMA, UMTS, WiBro or GSM). The wired communication may include at least one of, for example, a Universal Serial Bus (USB), a High Definition Multimedia Interface (HDMI®), Recommended Standard 232 (RS-232), and a Plain Old Telephone Service (POTS).

According to an embodiment, the server 106 supports driving of the electronic device 100 by performing at least one operation (or function) implemented by the electronic device 100. For example, the server 106 may include a communication control server module that supports the communication interface 170 implemented in the electronic device 100. For example, the communication control server module may include at least one of the components of the communication interface 170 to perform (on behalf of) at least one operations performed by the communication interface 170.

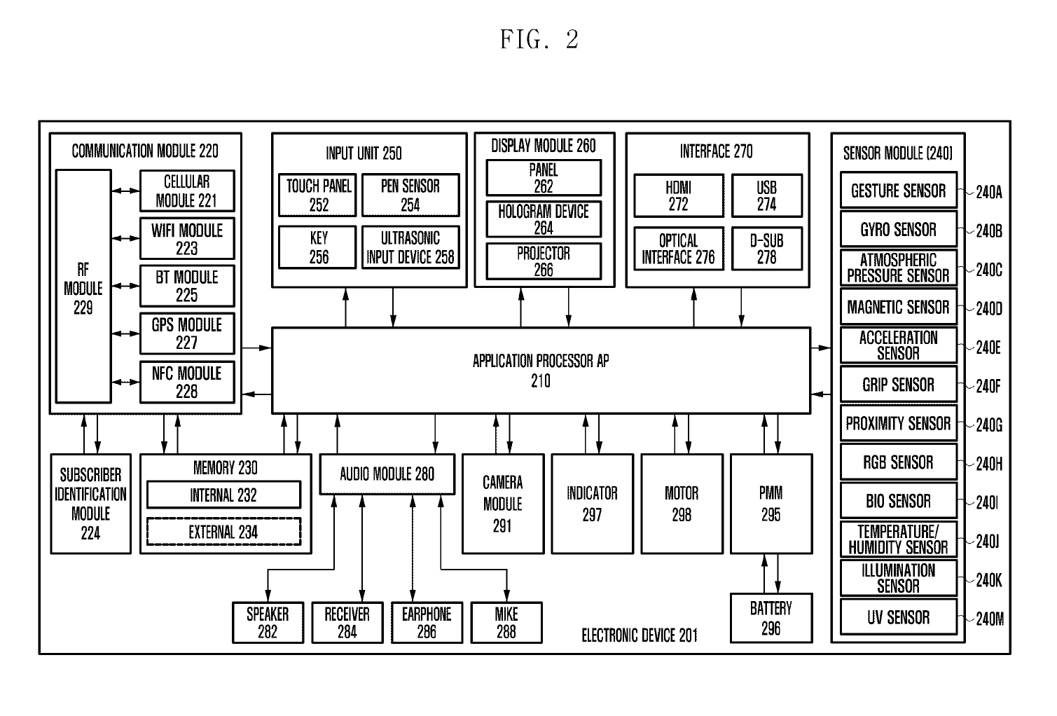

FIG. 2 illustrates a block diagram of an electronic device 200 according to various embodiments of the present disclosure. The electronic device 200 may represent, for example, a whole or a part of the electronic device 100 illustrated in FIG. 1. Referring to FIG. 2, the electronic device 200 includes one or more Application Processors (APs) 210, a communication interface 220, a Subscriber Identification Module (SIM) card 224, a memory 230, a sensor module 240, an input device 250, a display 260, an interface 270, an audio module 280, a camera module 291, a power managing module 295, a battery 296, an indicator 297, and a motor 298.

The AP 210 operates an operating system (OS) or an application program so as to control a plurality of hardware or software component elements connected to the AP 210 and execute various data processing and calculations including multimedia data. The AP 210 may be implemented by, for example, a System on Chip (SoC). According to an embodiment, the processor 210 may further include a Graphic Processing Unit (GPU).

The communication interface 220 (for example, communication interface 170) transmits/receives data in communication between different electronic devices (for example, the electronic device 104 and the server 106) connected to the electronic device 200 (for example, electronic device 100) through a network. According to an embodiment, the communication interface 220 includes a cellular module 221, a Wi-Fi® module 223, a BlueTooth® (BT) module 225, a Global Navigation Satellite System (GNSS) module 227, a Near Field Communication (NFC) module 228, and a Radio Frequency (RF) module 229. The Global Navigation Satellite System (GNSS) module 227 includes at least one of GPS(Global Positioning System), Glonass(Global Navigation Satellite System), Beidou Navigation Satellite System (“Beidou”) or the European global satellite-based navigation system(“Galileo”).

The cellular module 221 provides a voice, a call, a video call, a Short Message Service (SMS), or an Internet service through a communication network (for example, Long Term Evolution (LTE), LTE-A, Code Division Multiple Access (CDMA), Wideband CDMA (WCDMA), UMTS, WiBro, GSM or the like). Further, the cellular module 221 may distinguish and authenticate electronic devices within a communication network by using a subscriber identification module (for example, the SIM card 224). According to an embodiment, the cellular module 221 performs at least some of the functions which can be provided by the AP 210. For example, the cellular module 221 may perform at least some of the multimedia control functions.

According to an embodiment, the cellular module 221 may include a Communication Processor (CP). Further, the cellular module 221 may be implemented by, for example, an SoC.

According to an embodiment, the AP 210 or the cellular module 221 (for example, communication processor) may load a command or data received from at least one of a non-volatile memory and other components connected to each of the AP 210 and the cellular module 221 to a volatile memory and process the loaded command or data. Further, the AP 210 or the cellular module 221 may store data received from at least one of other components or generated by at least one of other components in a non-volatile memory.

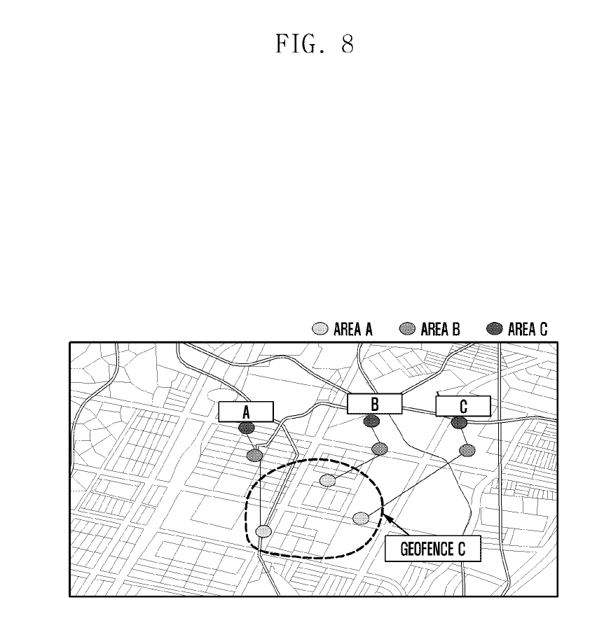

Each of the Wi-Fi® module 223, the BT module 225, the GNSS module 227, and the NFC module 228 may include, for example, a processor for processing data transmitted/received through the corresponding module. Although the cellular module 221, the Wi-Fi® module 223, the BT module 225, the GNSS module 227, and the NFC module 228 are illustrated as blocks separate from each other in FIG. 8, at least some (for example, two or more) of the cellular module 221, the Wi-Fi® module 223, the BT module 225, the GNSS module 227, and the NFC module 228 may be included in one Integrated Chip (IC) or one IC package according to one embodiment. For example, at least some (for example, the communication processor corresponding to the cellular module 221 and the ^{WiFi}® processor corresponding to the ^{WiFi}® module 223) of the processors corresponding to the cellular module 221, the Wi-Fi module 223, the BT module 225, the GNSS module 227, and the NFC module 228 may be implemented by one SoC.

The RF module 229 transmits/receives data, for example, an RF signal. Although not illustrated, the RF module 229 may include, for example, a transceiver, a Power Amp Module (PAM), a frequency filter, a Low Noise Amplifier (LNA) or the like. Further, the RF module 229 may further include a component for transmitting/receiving electronic waves over a free air space in wireless communication, for example, a conductor, a conducting wire, or the like. Although the cellular module 221, the Wi-Fi® module 223, the BT module 225, the GNSS module 227, and the NFC module 228 share one RF module 229 in FIG. 2, at least one of the cellular module 221, the Wi-Fi® module 223, the BT module 225, the GNSS module 227, and the NFC module 228 may transmit/receive an RF signal through a separate RF module according to one embodiment.

The SIM card 224 is a card including a Subscriber Identification Module and may be inserted into a slot formed in a particular portion of the electronic device. The SIM card 224 includes unique identification information (for example, Integrated Circuit Card IDentifier (ICCID)) or subscriber information (for example, International Mobile Subscriber Identity (IMSI).

The memory 230 (for example, memory 130) may include an internal memory 232 or an external memory 234. The internal memory 232 may include, for example, at least one of a volatile memory (for example, a Random Access Memory (RAM), a dynamic RAM (DRAM), a static RAM (SRAM), a synchronous dynamic RAM (SDRAM), and the like), and a non-volatile Memory (for example, a Read Only Memory (ROM), a one time programmable ROM (OTPROM), a programmable ROM (PROM), an erasable and programmable ROM (EPROM), an electrically erasable and programmable ROM (EEPROM), a mask ROM, a flash ROM, a NAND flash memory, an NOR flash memory, and the like).

According to an embodiment, the internal memory 232 may be a Solid State Drive (SSD). The external memory 234 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 234 may be functionally connected to the electronic device 200 through various interfaces. According to an embodiment, the electronic device 200 may further include a storage device (or storage medium) such as a hard drive.

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor 240H (for example, Red, Green, and Blue (RGB) sensor), a biometric sensor 2401, a temperature/humidity sensor 240J, an illumination (light) sensor 240K, and a Ultra Violet (UV) sensor 240M. Additionally or alternatively, the sensor module 240 may include, for example, a E-nose sensor, an electromyography (EMG) sensor, an electroencephalogram (EEG) sensor, an electrocardiogram (ECG) sensor, an InfraRed (IR) sensor, an iris sensor, a fingerprint sensor (not illustrated), and the like. The sensor module 240 may further include a control circuit for controlling one or more sensors included in the sensor module 240.

The input device 250 includes a touch panel 252, a (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 can recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a key pad. The ultrasonic input device 258 is a device which can detect an acoustic wave by a microphone (for example, microphone 288) of the electronic device 200 through an input means generating an ultrasonic signal to identify data and can perform wireless recognition. According to an embodiment, the electronic device 200 receives a user input from an external device (for example, computer or server) connected to the electronic device 200 by using the communication interface 220.

The display 260 (for example, display 160) includes a panel 262, a hologram device 264, and a projector 266. The panel 262 may be, for example, a Liquid Crystal Display (LCD) or an Active Matrix Organic Light Emitting Diode (AM-OLED). The panel 262 may be implemented to be, for example, flexible, transparent, or wearable. The panel 262 may be configured by the touch panel 252 and one module. The hologram device 264 shows a stereoscopic image in the air by using interference of light. The projector 266 projects light on a screen to display an image. For example, the screen may be located inside or outside the electronic device 200. According to an embodiment, the display 260 may further include a control circuit for controlling the panel 262, the hologram device 264, and the projector 266.

The interface 270 includes, for example, a High-Definition Multimedia Interface (HDMI®) 272, a Universal Serial Bus (USB) 274, an optical interface 276, and a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC), or an Infrared Data Association (IrDA) standard interface.

The audio module 280 bi-directionally converts a sound and an electronic signal. At least some components of the audio module 280 may be included in, for example, the input/output interface 150 illustrated in FIG. 1. The audio module 280 processes sound information input or output through, for example, a speaker 282, a receiver 284, an earphone 286, the microphone 288 or the like.

The camera module 291 is a device which can photograph a still image and a video. According to an embodiment, the camera module 291 may include one or more image sensors (for example, a front sensor or a back sensor), an Image Signal Processor (ISP) (not shown) or a flash (for example, an LED or xenon lamp).

The power managing module 295 manages power of the electronic device 200. Although not illustrated, the power managing module 295 may include, for example, a Power Management Integrated Circuit (PMIC), a charger Integrated Circuit (IC), or a battery or fuel gauge.

The PMIC may be mounted to, for example, an integrated circuit or an SoC semiconductor. A charging method may be divided into wired and wireless methods. The charger IC charges a battery and prevent over voltage or over current from flowing from a charger. According to an embodiment, the charger IC includes a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier or the like may be added.

The battery fuel gauge measures, for example, a remaining quantity of the battery 296, or a voltage, a current, or a temperature during charging. The battery 296 may store or generate electricity and supply power to the electronic device 200 by using the stored or generated electricity. The battery 296 may include a rechargeable battery or a solar battery. The indicator 297 shows particular statuses of the electronic device 200 or a part (for example, AP 210) of the electronic device 200, for example, a booting status, a message status, a charging status and the like. The motor 298 converts an electrical signal to a mechanical vibration.

Although not illustrated, the electronic device 200 may include a processing unit (for example, GPU) for supporting a module TV. The processing unit for supporting the mobile TV may process, for example, media data according to a standard of Digital Multimedia Broadcasting (DMB), Digital Video Broadcasting (DVB), media flow or the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, a few of the components may be omitted, or additional components may be further included. Also, some of the components of the electronic device according to various embodiments of the present disclosure may be combined to form a single entity, and thus may equivalently execute functions of the corresponding components before being combined.

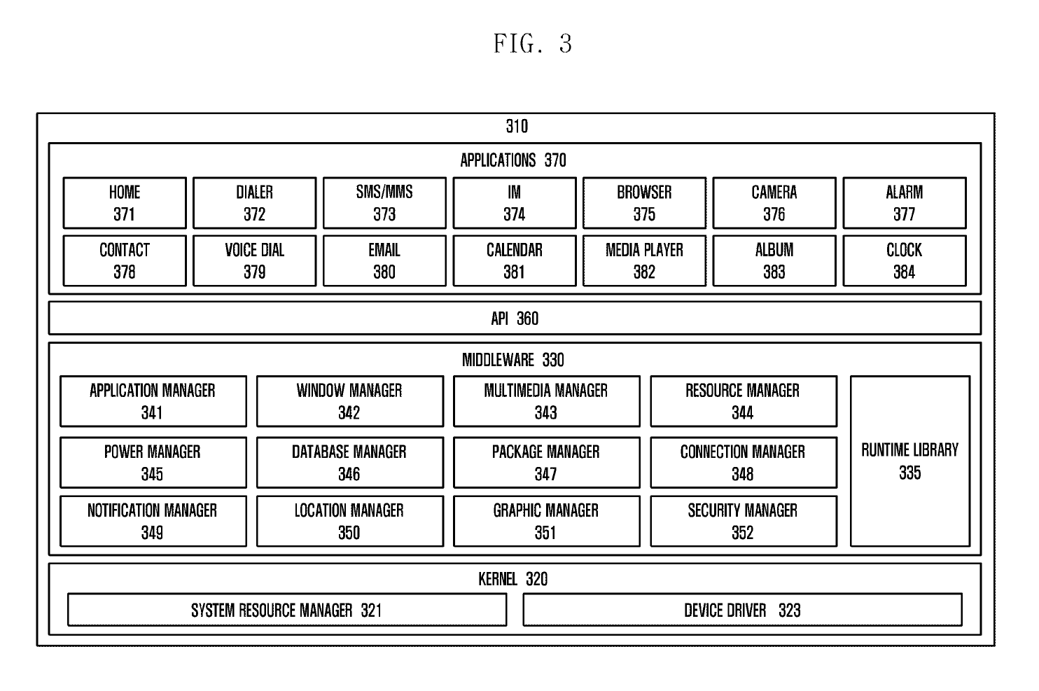

FIG. 3 illustrates a block diagram of a programming module 310 according to an embodiment. The programming module 310(for example, programming module 140) may be included (stored) in the electronic device 100 (for example, memory 130) illustrated in FIG. 1. At least some of the programming module 310 may be formed of software, firmware, hardware, or a combination of at least two of software, firmware, and hardware. The programming module 310 may be executed in the hardware (for example, electronic device 200) to include an Operating System (OS) controlling resources related to the electronic device (for example, electronic device 100) or various applications (for example, applications 370) driving on the OS. For example, the OS may be Android, iOS, Windows, Symbian, Tizen, Bada or the like. Referring to FIG. 3, the programming module 310 includes a kernel 320, a middleware 330, an Application Programming Interface (API) 360, and applications 370.

The kernel 320 (for example, kernel 141) includes a system resource manager 321 and a device driver 323. The system resource manager 321 may include, for example, a process manager, a memory manager, and a file system manager. The system resource manager 321 performs a system resource control, allocation, and recall. The device driver 323 may include, for example, a display driver, a camera driver, a Bluetooth° driver, a shared memory driver, a USB driver, a keypad driver, a WiFi® driver, and an audio driver. Further, according to an embodiment, the device driver 323 may include an Inter-Process Communication (IPC) driver. The middleware 330 includes a plurality of modules prepared in advance to provide a function used in common by the applications 370. Further, the middleware 330 provides a function through the API 360 to allow the application 370 to efficiently use limited system resources within the electronic device. For example, as illustrated in FIG. 3, the middleware 330 (for example, middleware 143) includes at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352. The runtime library 335 includes, for example, a library module used by a complier to add a new function through a programming language while the application 370 is executed. According to an embodiment, the runtime library 335 executes input and output, management of a memory, a function associated with an arithmetic function and the like. The application manager 341 manages, for example, a life cycle of at least one of the applications 370. The window manager 342 manages GUI resources used on the screen. The multimedia manager 343 detects a format used for reproducing various media files and performs an encoding or a decoding of a media file by using a codec suitable for the corresponding format. The resource manager 344 manages resources such as a source code, a memory, or a storage space of at least one of the applications 370.

The power manager 345 operates together with a Basic Input/Output System (BIOS) to manage a battery or power and provides power information used for the operation. The database manager 346 manages generation, search, and change of a database to be used by at least one of the applications 370. The package manager 347 manages an installation or an update of an application distributed in a form of a package file.

The connection manager 348 manages, for example, a wireless connection such as Wi-Fi or Bluetooth®. The notification manager 349 displays or notifies a user of an event such as an arrival message, an appointment, a proximity alarm or the like, in a manner that does not disturb the user. The location manager 350 manages location information of the electronic device. The graphic manager 351 manages a graphic effect provided to the user or a user interface related to the graphic effect. The security manager 352 provides a general security function used for a system security or a user authentication. According to an embodiment, when the electronic device (for example, electronic device 100 or 200) has a call function, the middleware 330 may further include a telephony manager for managing a voice of the electronic device or a video call function. The middleware 330 may generate a new middleware module through a combination of various functions of the aforementioned internal component modules and use the generated new middleware module. The middleware 330 may provide a module specified for each type of operating system to provide a differentiated function. Further, the middleware 330 may dynamically delete some of the conventional components or add new components. Accordingly, some of the components described in the embodiment of the present disclosure may be omitted, replaced with other components having different names but performing similar functions, or other components may be further included.

The API 360 (for example, API 145) is a set of API programming functions, and may be provided with a different configuration according to an operating system. For example, in Android or iOS, a single API set may be provided for each platform. In Tizen, two or more API sets may be provided. The applications 370, which may include an application similar to the application 134, may include, for example, a preloaded application and/or a third party application. The applications 370 may include a home application 371 a dialer application 372, a Short Messaging Service (SMS)/Multlimedia Messaging Service (MMS) application 373, an Instant Messaging (IM) application 374, a browser application 375, a camera application 376, an alarm application 377, a contact application 378, a voice dial application 379, an email application 380, a calendar application 381, a media player application 382, an album application 383, and a clock application 384. However, the present embodiment is not limited thereto, and the applications 370 may include any other similar and/or suitable application. At least a part of the programming module 310 can be implemented by commands stored in computer-readable storage media. When the commands are executed by at least one processor, e.g. the AP 210, at least one processor can perform functions corresponding to the commands. The computer-readable storage media may be, for example, the memory 230. At least a part of the programming module 310 can be implemented, e.g. executed, by, for example, the AP 210. At least a part of the programming module 310 may include, for example, a module, a program, a routine, a set of instructions and/or a process for performing at least one function.

The titles of the aforementioned elements of the programming module, e.g. the programming module 310, according to the present disclosure may vary depending on the type of the OS. The programming module according to the present disclosure may include at least one of the aforementioned elements and/or may further include other additional elements, and/or some of the aforementioned elements may be omitted. The operations performed by a programming module and/or other elements according to the present disclosure may be processed through a sequential, parallel, repetitive, and/or heuristic method, and some of the operations may be omitted and/or other operations may be added.

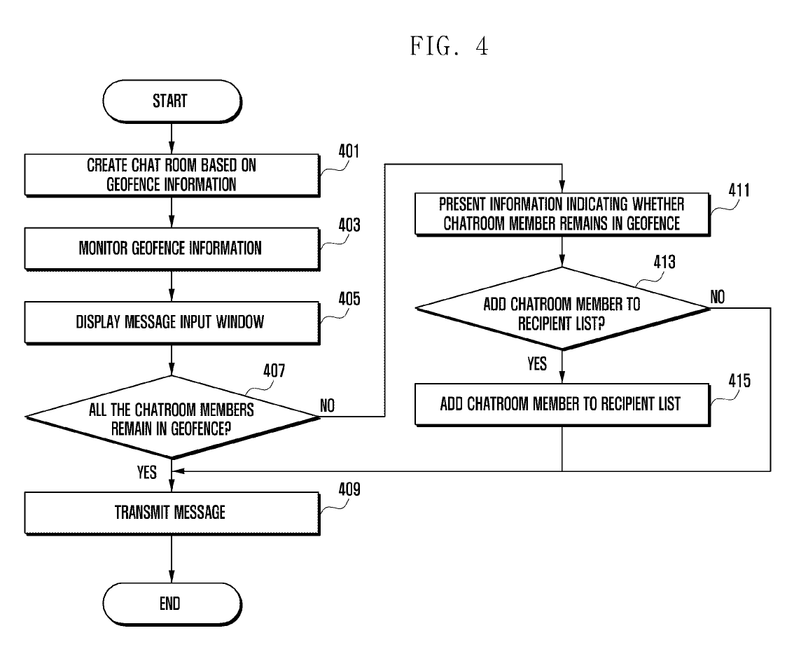

FIG. 4 illustrates a flowchart of a procedure for handling messages based on location information of the electronic device 201 according to various embodiments of the present disclosure.

Referring to FIG. 4, at step 401, the processor 210 of the electronic device 201 may create a chat room based on geofence information.

In one embodiment, the processor 210 of the electronic device 201 may receive a user input for chatroom creation, and create a chat room by using a messenger application installed in the electronic device 201 (e.g. IM application 374).

In one embodiment, the electronic device 201 may configure a geofence and create a chat room on the basis of the geofence information. The electronic device 201 may receive geofence information from a specific server (e.g. messenger server, or SNS server like the server 106) and create a chat room on the basis of the received geofence information. The electronic device 201 may receive geofence information for geofence configuration from a specific server (e.g. server 106) by use of geofence information of an electronic device (e.g. electronic device 102) of a different user being a member of the chat room. In one embodiment, a geofence may be configured according to a contact group (e.g. company, family, or friend) present in the contact list. For example, when each of members belonging to the chat room has contact group information “company” as category information, the electronic device 201 or the server (e.g. messenger server, or SNS server like the server 106) may set geofence information to “company”.

In various embodiments, a geofence refers to a virtual perimeter for a real-world geographic area, and may be an example of a location-based service (LBS). A geofence may be dynamically generated on demand (e.g. as in a radius of 100 m around a store or point location). A geofence can be a predefined set of boundaries (e.g. school attendance zones or administrative districts). The geofence area is commonly of a circular shape, but may be of a different shape according to user input.

In one embodiment, the electronic device 201 may periodically obtain or measure location information thereof using a location measurement sensor (e.g. communication module 220 or GNSS module 227). The electronic device 201 may determine a significant location thereof on the basis of obtained or measured location information. The electronic device 201 may configure a geofence on the basis of the significant location. Here, the significant location of the electronic device 201 may be a place at which the user of the electronic device 201 remains for a given time on a periodic basis.

In one embodiment, the electronic device 201 may use the communication module 220 to receive location information of an electronic device (e.g. electronic device 102 or 104) of a member of the chat room. The processor 210 of the electronic device 201 may determine the significant location of the electronic device 201 on the basis of at least one of location information of the electronic device 201 and location information of the external electronic device (e.g. electronic device 102 or 104) of the member. The electronic device 201 may configure a geofence on the basis of information on the significant location.

In one embodiment, the electronic device 201 may configure a geofence according to user input. For example, in a state where a map of a geographic region is displayed on the display 260 having the touch panel 252, when the user draws a closed curve on the map, the electronic device 201 may configure the area inside the closed curve as a geofence. As another example, when the user enters the address of a specific area, the electronic device 201 may configure the area indicated by the address as a geofence. After configuring a geofence, the electronic device 201 may use the location measurement sensor (e.g. communication module 220 or GNSS module 227) to monitor whether the electronic device 201 enters or leaves the geofence.

In one embodiment, after configuring a geofence, the electronic device 201 may send information on the geofence to a specific server (e.g. messenger server, or SNS server like the server 106).

In one embodiment, when the electronic device 201 sends the obtained or measured location information to a specific server (e.g. messenger server, or SNS server like the server 106), the server may determine the significant location and configure a geofence according to the received location information. The server may send information on the configured geofence to the electronic device 201.

In one embodiment, the electronic device 201 and an electronic device (e.g. electronic device 102 or 104) of a chatroom member may send obtained location information to a specific server (e.g. messenger server, or SNS server like the server 106). The server may configure a geofence on the basis of at least one of the location information of the electronic device 201 and the location information of the electronic device (e.g. electronic device 102 or 104) of the chatroom member.

At step 403, the processor 210 of the electronic device 201 may monitor the state of the geofence.

In one embodiment, monitoring the state of the geofence may include at least one of monitoring whether the electronic device 201 remains in the geofence and monitoring whether the electronic device (e.g. electronic device 102 or 104) of a chatroom member remains in the geofence.

In one embodiment, the electronic device 201 may use the location measurement sensor (e.g. communication module 220 or GNSS module 227) to monitor whether the electronic device 201 enters or exits the configured geofence. The electronic device 201 may send a geofence entry or exit notification to the server (e.g. messenger server, or SNS server like the server 106).

In one embodiment, the electronic device 201 may receive information indicating whether the electronic device (e.g. electronic device 102 or 104) of a chatroom member has entered or exited the geofence from the server (e.g. messenger server, or SNS server like the server 106).

In one embodiment, the electronic device 201 may use a geofence manager (e.g. location manager 350) to configure a geofence on the basis of at least one of the location information of the electronic device 201 and the location information of the electronic device (e.g. electronic device 102 or 104) of a chatroom member.

In one embodiment, the electronic device 201 may use the geofence manager (e.g. location manager 350) to monitor whether the electronic device 201 remains in the geofence and to monitor whether the electronic device (e.g. electronic device 102 or 104) of a chatroom member remains in the geofence.

At step 405, the processor 210 of the electronic device 201 may display a message input window on the display 260.

At step 407, the processor 210 of the electronic device 201 may determine whether all the chatroom members remain in the configured geofence.

In one embodiment, the electronic device 201 may receive information indicating whether the electronic device (e.g. electronic device 102 or 104) of a chatroom member has entered or exited the geofence from the server (e.g. messenger server, or SNS server like the server 106) and determine whether all the chatroom members remain in the configured geofence.

In one embodiment, step 407 may be performed by the server. That is, the server (e.g. messenger server, or SNS server like the server 106) may determine whether all the chatroom members remain in the configured geofence.

Upon determining that all the chatroom members remain in the configured geofence at step 407, the procedure proceeds to step 409.

At step 409, the processor 210 of the electronic device 201 may use the communication module 220 to transmit the input message. The message may contain characters or words entered by the user of the electronic device 201 into the message input window of step 405.

In one embodiment, the electronic device 201 may use the communication module 220 to try message transmission according to the message to be posted to the chat room created based on the geofence information, and a message transmission request.

In one embodiment, the electronic device 201 may forward the message to be posted to the chat room created based on the geofence information and a message transmission request to the server (e.g. messenger server, or SNS server like the server 106).

Upon determining that all the chatroom members do not remain in the configured geofence at step 407, the procedure proceeds to step 411.

At step 411, the processor 210 of the electronic device 201 may present information indicating whether a specific chatroom member remains in the geofence.

For example, the processor 210 of the electronic device 201 may present information on those chatroom members remaining in the geofence separately from information on those chatroom members not remaining in the geofence. The processor 210 may display a chat room window enabling the user to remove a chatroom member not remaining in the geofence from the recipient list or to add a chatroom member not remaining in the geofence to the recipient list.

In one embodiment, to present information indicating whether a specific chatroom member remains in the geofence, the electronic device 201 may output at least one of information (e.g. name) on a chatroom member having exited the geofence and an indication to whether to add a chatroom member having exited the geofence to the recipient list on the display 260. The information (e.g. name) on a chatroom member having exited the geofence may be output as text data or image data in a GUI window on the display 260. The indication to whether to add a chatroom member having exited the geofence to the recipient list may be output as text data or image data in a GUI window on the display 260.

At step 413, the processor 210 of the electronic device 201 may determine whether to add a chatroom member having exited the geofence to the recipient list.

In one embodiment, the electronic device 201 may output a GUI window presenting the information indicating whether to add a chatroom member having exited the geofence to the recipient list as text data or image data on the display 260, and receive a user input for deciding whether to add a chatroom member having exited the geofence to the recipient list.

Upon determining to add a chatroom member having exited the geofence to the recipient list at step 413, the procedure proceeds to step 415.

At step 415, the processor 210 of the electronic device 201 may add a chatroom member having exited the geofence to the recipient list. Thereafter, a chat room message may also be sent to the chatroom member who does not remains in the geofence but is newly added to the recipient list.

Upon determining not to add a chatroom member having exited the geofence to the recipient list at step 413, the procedure proceeds to step 409, at which a chat room message may be sent to the chatroom members except for those not remaining in the geofence.

In one embodiment, the server (e.g. messenger server, or SNS server like the server 106) may include a chat room manager. The chat room manager may create a chat room, manage the membership of the chat room, identify the geofence location at which a particular chatroom member is present to control message transmission, and permit electronic devices of the chatroom members to share the geofence information. The server may monitor whether a particular chatroom member enters or exits the geofence, and enable electronic devices of the chatroom members to share the monitoring results in a synchronized manner.

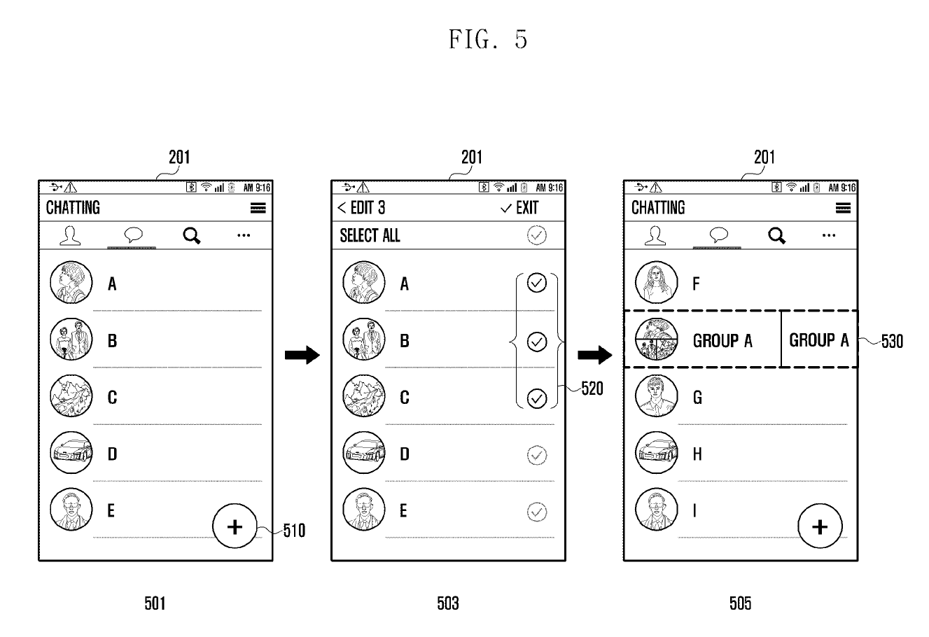

FIG. 5 illustrates creation of a chat room based on geofence information of the electronic device 201 according to various embodiments of the present disclosure.

As indicated by indicia 501, the electronic device 201 may output entries of the contact list (e.g. A, B, C, D, E, F) on the display 260. The electronic device 201 may also output a GUI element 510 containing at least one of text data and image data for chatroom creation on the display 260.

As indicated by indicia 503, when a user input (e.g. touch event) selecting the GUI element 510 for chatroom creation is received from the touch panel 252, the electronic device 201 may output a GUI element 520 containing at least one of text data and image data for chatroom member selection on the display 260.

As indicated by indicia 505, when a user input (e.g. touch event) selecting the GUI element 520 for chatroom member selection is received from the touch panel 252, the electronic device 201 may create a chat room 530 with the selected members on the basis of geofence information. The chat room 530 may be displayed in a GUI window on the display 260.

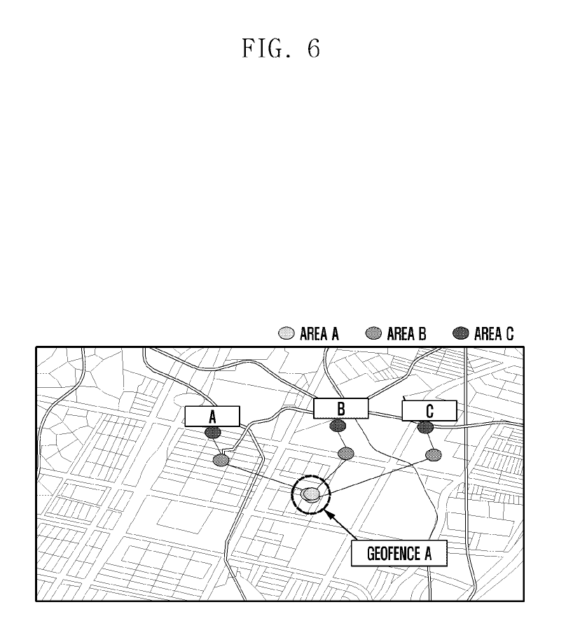

FIGS. 6 to 9 illustrate configuration of a geofence according to various embodiments of the present disclosure.

Referring to FIG. 6, significant locations for members A, B, C may be area A (e.g. company), area B (e.g. home), and area C (e.g. church). If the significant location common to all members A, B, C is area A, the electronic device 201 may configure area A as geofence A on the basis of location information received from other electronic devices, and may create a chat room with members A, B, C on the basis of geofence A.

In one embodiment, if the significant location to all members A, B, C is area A, when a chat room with members A, B, C is created, the server (e.g. messenger server, or SNS server like the server 106) may set geofence information to indicate geofence A.

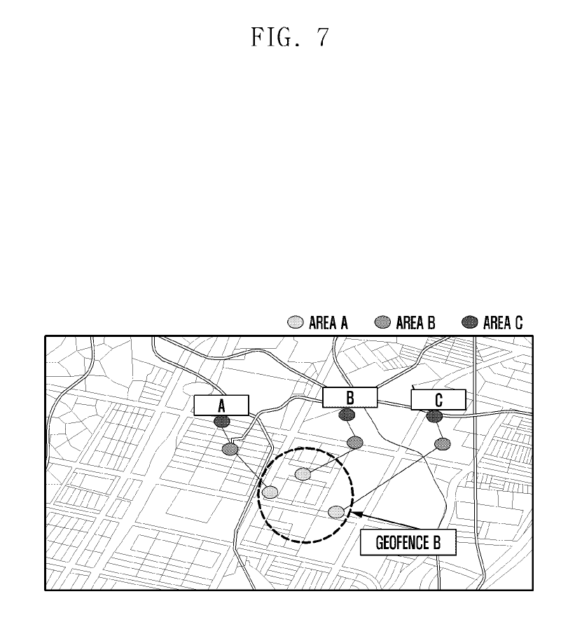

Referring to FIG. 7, significant locations for members A, B, C may be area A (e.g. company), area B (e.g. home), and area C (e.g. church). If the significant location common to members A, B, C is area A and area A is a relatively large area like a business complex with separate subareas, the electronic device 201 may create a chat room based on geofence B covering large area A in full.

In one embodiment, if the significant location common to members A, B, C is area A and area A is a relatively large area like a business complex with separate subareas, when a chat room with members A, B, C is created, the server (e.g. messenger server, or SNS server like the server 106) may set geofence information to indicate geofence B covering relatively large area A in full.

Referring to FIG. 8, significant locations for members A, B, C may be area A (e.g. company), area B (e.g. home), and area C (e.g. church). If the significant location common to members A, B, C is area A and area A is a relatively large area like a business complex with separate subareas, the electronic device 201 may obtain address information of area A from location information (e.g. latitude and longitude) of relatively large area A, configure geofence C on the basis of the obtained address information, and create a chat room based on geofence C.

In one embodiment, if the significant location common to members A, B, C is area A and area A is a relatively large area like a business complex with separate subareas, when a chat room with members A, B, C is created, the server (e.g. messenger server, or SNS server like the server 106) may obtain address information of area A from location information (e.g. latitude and longitude) of relatively large area A, and configure geofence C on the basis of the obtained address information.

In particular, land-use information contained in a map may be utilized to configure areas that have the same land use and are a significant location common to members A, B, C as a geofence.

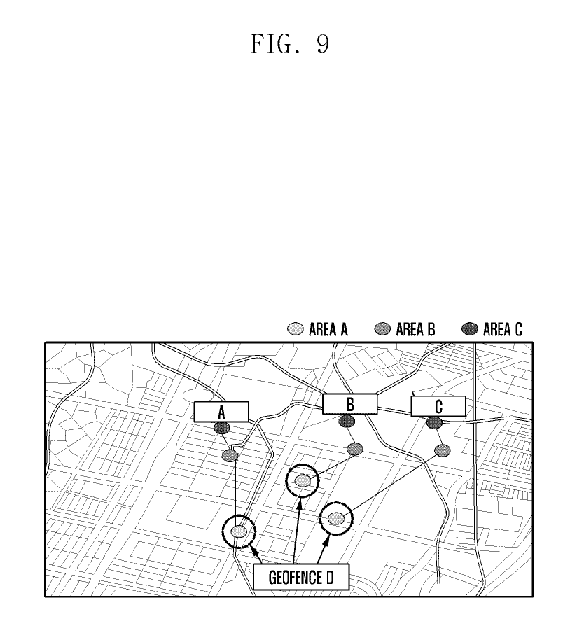

Referring to FIG. 9, significant locations for members A, B, C may be area A (e.g. company), area B (e.g. home), and area C (e.g. church). If the significant location common to members A, B, C is area A and area A is a relatively large area, the electronic device 201 may configure each subarea of area A as a geofence, and manage the multiple geofences as a unified geofence (geofence D).

In one embodiment, if the significant location common to members A, B, C is area A and area A is a relatively large area with separate subareas, when a chat room with members A, B, C is created, the server (e.g. messenger server, or SNS server like the server 106) may configure each subarea of area A as a geofence, and manage the multiple geofences as a unified geofence (geofence D).

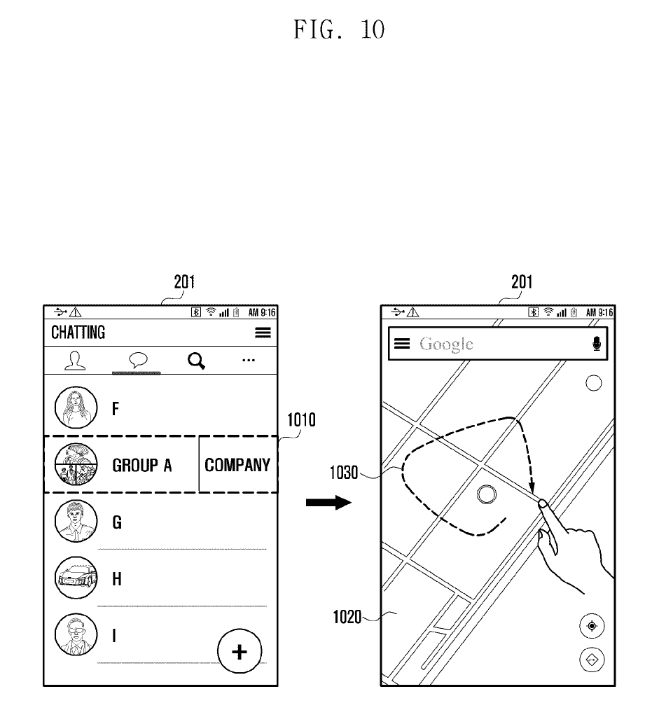

FIG. 10 illustrates screen representations for configuring a geofence according to various embodiments of the present disclosure.

When a chat room with two or more members is created, the electronic device 201 may display the created chat room 1010 on the display 260. Thereafter, the electronic device 201 may display a map 1020 on the display 260 and configure a geofence 1030 on the map 1020 according to user input (e.g. touch event).

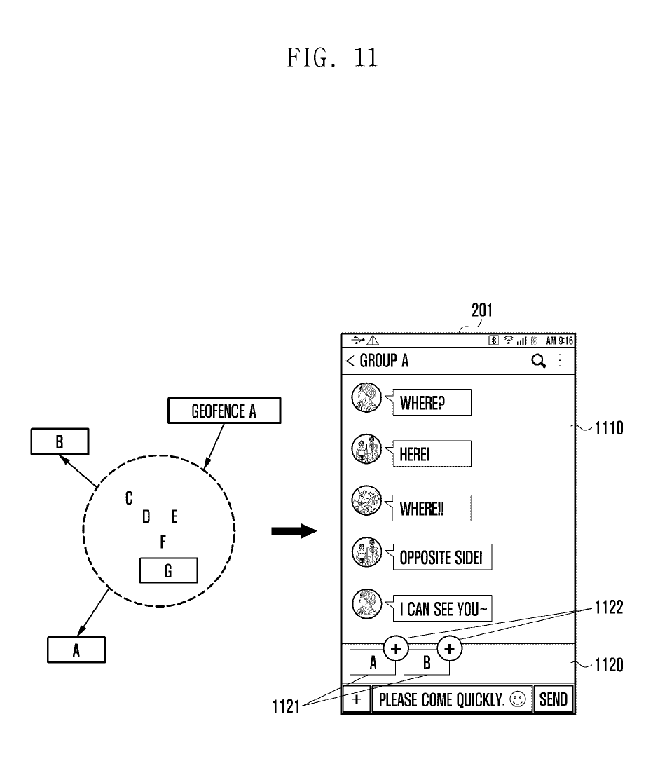

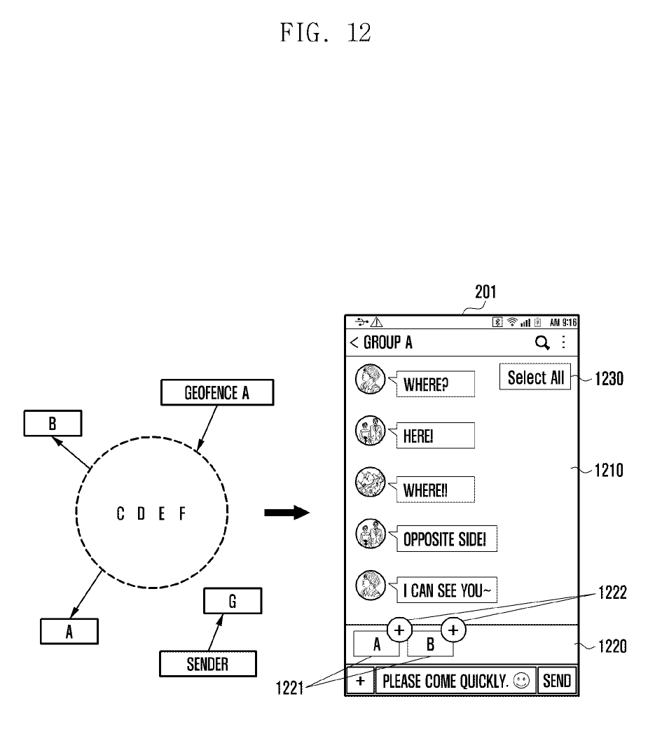

FIGS. 11 and 12 illustrate transmission of messages according to various embodiments of the present disclosure.

Referring to FIG. 11, assume that a chat room 1110 with members A to G is created based on geofence A. When member G tries to send a message by using the electronic device 201, the electronic device 201 may output information on members A and B remaining outside geofence A in a GUI window 1120 on the display 260. The GUI window 1120 for presenting information on members A and B remaining outside geofence A may include an item 1121 indicating the names of members A and B, and a GUI element 1122 for addition to the recipient list. For example, when a user input for selecting at least one of the item 1121 and the GUI element 1122 is received through the touch panel 252, the electronic device 201 may use the communication module 220 to send a message to at least one of member A and member B remaining outside geofence A in addition to those members remaining in geofence A.

Referring to FIG. 12, assume that a chat room 1210 with members A to G is created based on geofence A. When member G remaining outside geofence A tries to send a message by using the electronic device 201, the electronic device 201 may output information on members A and B remaining outside geofence A in a GUI window 1220 on the display 260. The GUI window 1220 for presenting information on members A and B remaining outside geofence A may include an item 1221 indicating the names of members A and B, and a GUI element 1222 for addition to the recipient list. The electronic device 201 may also output a GUI element 1230 to select all members remaining outside geofence A as a recipient. For example, when a user input for selecting at least one of the item 1221 and the GUI element 1222 is received through the touch panel 252, the electronic device 201 may use the communication module 220 to send a message to at least one of member A and member B remaining outside geofence A in addition to those members remaining in geofence A. When a user input for selecting the GUI element 1230 is received through the touch panel 252, the electronic device 201 may use the communication module 220 to send a message to all members remaining outside geofence A in addition to those members remaining in geofence A.

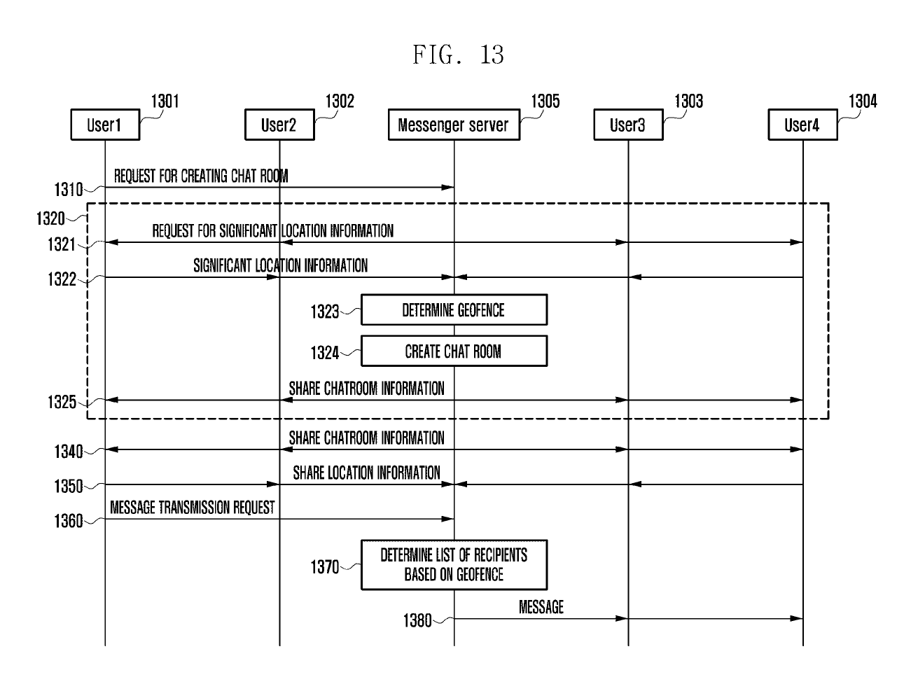

FIG. 13 illustrates a sequence diagram depicting signal flows between the server and electronic devices for geofence-based messenger operation according to various embodiments of the present disclosure.

In FIG. 13, the first to fourth electronic devices 1301, 1302, 1303, 1304 are electronic devices carried respectively by users or members participating in a chat room, and the server 1305 (e.g. server 106) may be a messenger server or SNS server.

At step 1310, the first electronic device 1301 (e.g. electronic device 201) may send the server 1305 a request for creating a chat room with the second to fourth electronic devices 1302, 1303, 1304 as members.

Upon reception of a request for creating a chat room from the first electronic device 1301, at step 1320, the server 1305 (e.g. server 106) may configure a geofence and create a chat room on the basis of the geofence information of the first to fourth electronic devices 1301, 1302, 1303, 1304.

More specifically, in response to the chatroom creation request from the first electronic device 1301, the server 1305 may configure a geofence and create a chat room as follows.

At step 1321, the server 1305 may send a request for significant location information to the first to fourth electronic devices 1301, 1302, 1303, 1304.

At step 1322, the first to fourth electronic devices 1301, 1302, 1303, 1304 may send the server 1305 their significant location information on the basis of their obtained or measured location information.

At step 1323, the server 1305 may configure a geofence for the first to fourth electronic devices 1301, 1302, 1303, 1304 on the basis of the received significant location information.

At step 1324, the server 1305 may create a chat room based on the geofence information for the first to fourth electronic devices 1301, 1302, 1303, 1304.

At step 1325, the server 1305 may notify the first to fourth electronic devices 1301, 1302, 1303, 1304 of chatroom creation to share the chatroom information.

At step 1340, the first to fourth electronic devices 1301, 1302, 1303, 1304 may report their location information to the server 1305 on a periodic basis, on an aperiodic basis, or on request.

In one embodiment, reporting location information to the server 1305 may include sending a geofence entry notification or geofence exit notification to the server 1305 on a periodic basis, on an aperiodic basis, or on request.

At step 1350, the server 1305 may notify the first to fourth electronic devices 1301, 1302, 1303, 1304 of the received location information to share the location information.

At step 1360, the first electronic device 1301 (e.g. electronic device 201) may send a message transmission request to the server 1305.

Upon reception of a message transmission request from the first electronic device 1301, at step 1370, the server 1305 may determine a list of recipients on the basis of the geofence. For example, the list of recipients may be determined according to whether each of the first to fourth electronic devices 1301, 1302, 1303, 1304 has entered the geofence.

Upon determining the list of recipients, at step 1380, the server 1305 may send a message to members belonging to the recipient list. For example, when the third electronic device 1303 and the fourth electronic device 1304 remain in the geofence and the second electronic device 1302 does not remain in the geofence, the server 1305 may send a message to the third electronic device 1303 and the fourth electronic device 1304 in response to the message transmission request from the first electronic device 1301.

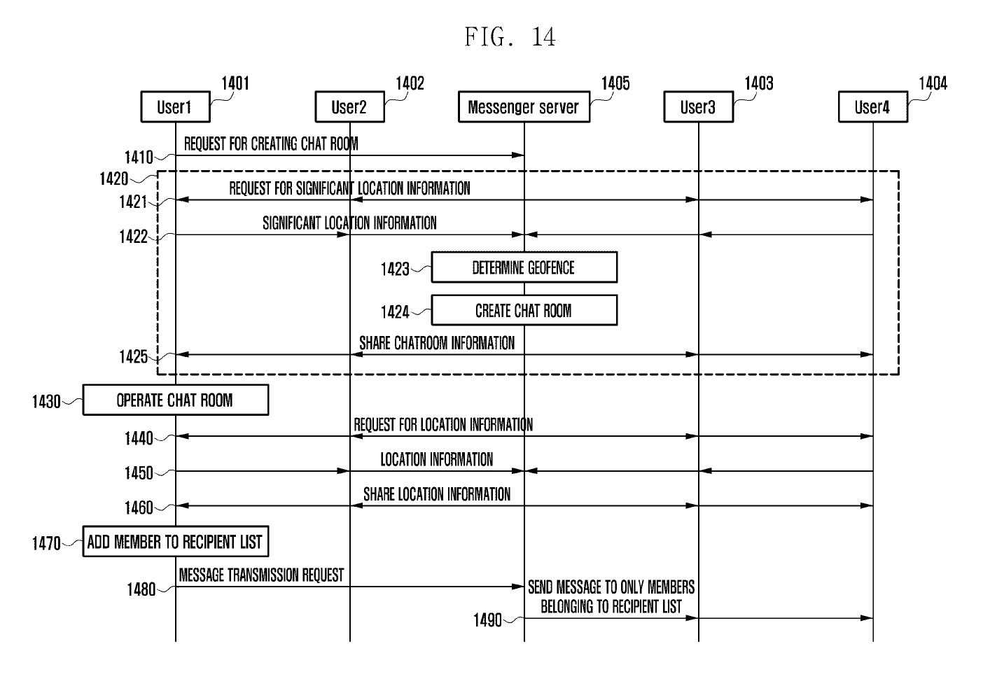

FIG. 14 illustrates a sequence diagram depicting signal flows between the server and electronic devices for geofence-based messenger operation according to various embodiments of the present disclosure.

In FIG. 14, the first to fourth electronic devices 1401, 1402, 1403, 1404 are electronic devices carried respectively by users or members participating in a chat room, and the server 1405 (e.g. server 106) may be a messenger server or SNS server.

At step 1410, the first electronic device 1401 (e.g. electronic device 201) may send the server 1405 a request for creating a chat room with the second to fourth electronic devices 1402, 1403, 1404 as members.

Upon reception of a request for creating a chat room from the first electronic device 1401, at step 1420, the server 1405 (e.g. server 106) may configure a geofence and create a chat room on the basis of the geofence information of the first to fourth electronic devices 1401, 1402, 1403, 1404.

More specifically, in response to the chatroom creation request from the first electronic device 1401, the server 1405 may configure a geofence and create a chat room as follows.

At step 1421, the server 1405 may send a request for significant location information to the first to fourth electronic devices 1401, 1402, 1403, 1404.

At step 1422, the first to fourth electronic devices 1401, 1402, 1403, 1404 may send the server 1405 their significant location information on the basis of their obtained or measured location information.

At step 1423, the server 1405 may configure a geofence for the first to fourth electronic devices 1401, 1402, 1403, 1404 on the basis of the received significant location information.

At step 1424, the server 1405 may create a chat room based on the geofence information for the first to fourth electronic devices 1401, 1402, 1403, 1404.

At step 1425, the server 1405 may notify the first to fourth electronic devices 1401, 1402, 1403, 1404 of chatroom creation to share the chatroom information.

At step 1430, the first electronic device 1401 may operate the chat room.

At step 1440, the server 1405 may send a request for location information to the first to fourth electronic devices 1401, 1402, 1403, 1404.

At step 1450, the first to fourth electronic devices 1401, 1402, 1403, 1404 may report their location information to the server 1405 on a periodic basis, on an aperiodic basis, or on request.

In one embodiment, reporting location information to the server 1405 may include sending a geofence entry notification or geofence exit notification to the server 1405 on a periodic basis, on an aperiodic basis, or on request.

At step 1460, the server 1405 may notify the first to fourth electronic devices 1401, 1402, 1403, 1404 of the received location information to share the location information.

At step 1470, the server 1405 may add a member remaining outside the geofence to the recipient list on the basis of the location information received from the first to fourth electronic devices 1401, 1402, 1403, 1404.

At step 1480, the first electronic device 1401 (e.g. electronic device 201) may send a message transmission request to the server 1405.

Upon reception of a message transmission request from the first electronic device 1401, at step 1490, the server 1405 may send a message to members belonging to the recipient list.

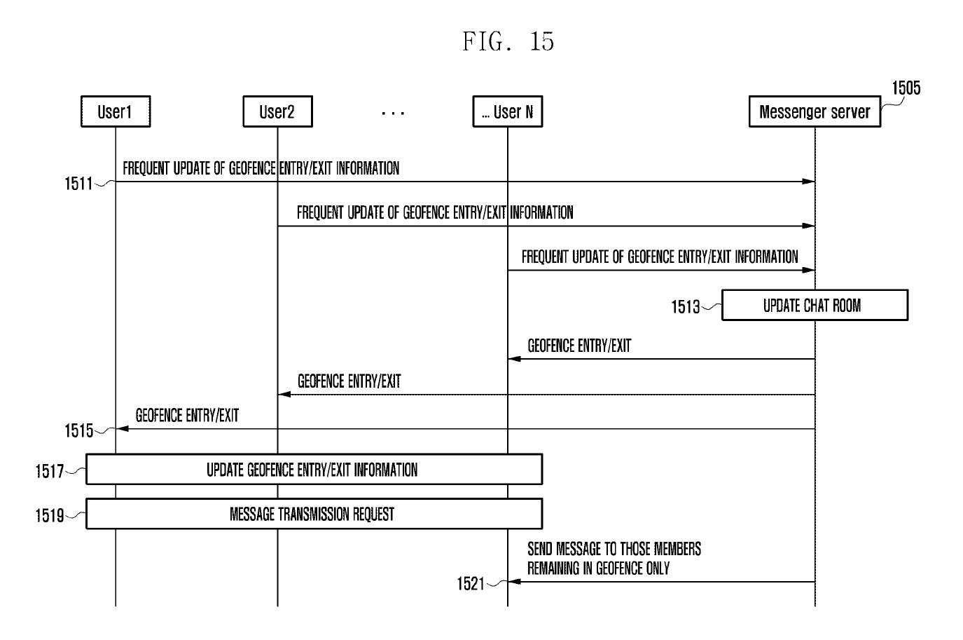

FIG. 15 illustrates a sequence diagram depicting signal flows between the server and electronic devices for geofence-based messenger operation according to various embodiments of the present disclosure.

In FIG. 15, the 1^{st} to N^{th} electronic devices (User 1, User 2, . . . , User N) are electronic devices carried respectively by users or members participating in a chat room, and the server 1505 (e.g. server 106) may be a messenger server or SNS server.

At step 1511, the 1^{st} to N^{th} electronic devices may update their geofence entry/exit status information stored in the server 1505 at regular intervals.

At step 1513, the server 1505 may update the chat room.

At step 1515, the server 1505 may send the geofence entry/exit status information to the 1^{st} to N^{th} electronic devices.

At step 1517, each of the 1^{st} to N^{th} electronic devices may update the geofence entry/exit status information of the other devices to have up-to-date geofence entry/exit status information.

At step 1519, at least one of the 1^{st} to N^{th} electronic devices may send a message transmission request to the server 1505.

At step 1521, the server 1505 may send a message to those electronic devices remaining in the geofence among the 1^{st} to N^{th} electronic devices.

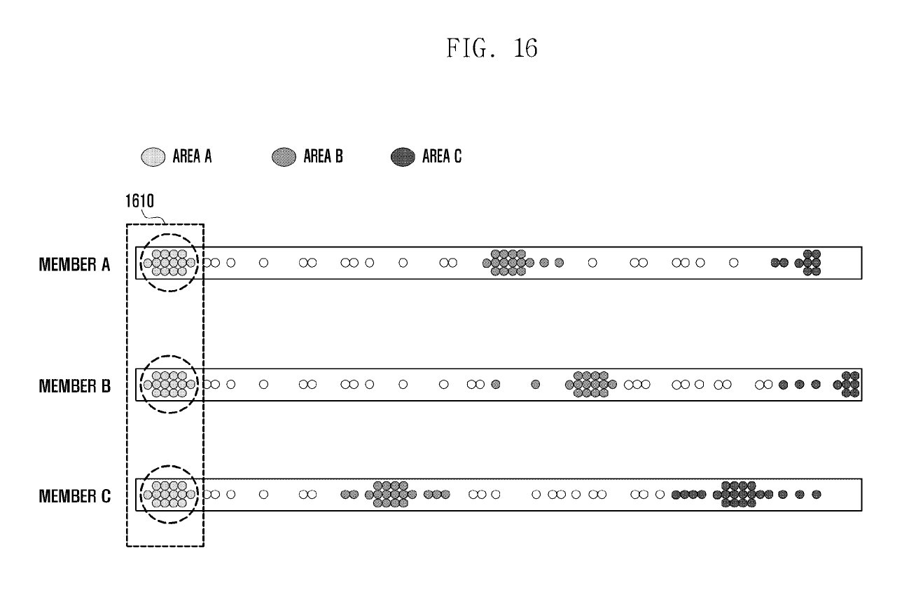

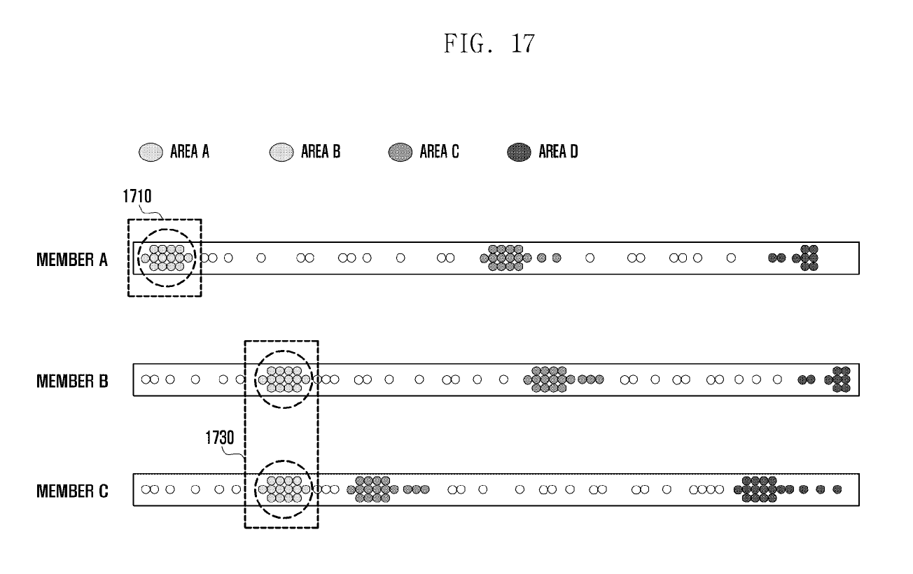

FIGS. 16 and 17 illustrate configuration of a geofence according to various embodiments of the present disclosure.

Referring to FIG. 16, significant locations for members A, B, C may be area A, area B, and area C. When the significant location common to members A, B, C is area A, the electronic device 201 may configure area A as a geofence 1610 on the basis of the received location information, and create a chat room based on the geofence 1610 for members A, B, C.

Referring to FIG. 17, significant locations for members A, B, C may be area A, area B, area C, and area D. When the significant location for member A is area A and the significant location common to members B and C is area B, the electronic device 201 may configure area A as a first geofence 1710, configure area B as a second geofence 1730, and combine the first geofence 1710 and second geofence 1730 into a multi-geofence for unified management.

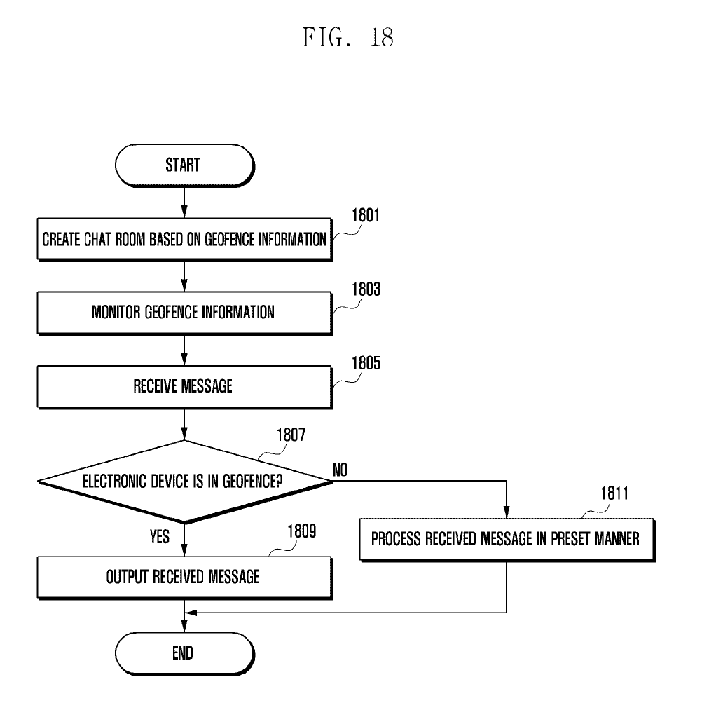

FIG. 18 illustrates a flowchart of a procedure for messenger operation based on location information of the electronic device 201 according to various embodiments of the present disclosure.

Referring to FIG. 18, at step 1801, the processor 210 of the electronic device 201 may create a chat room based on geofence information.

At step 1803, the processor 210 of the electronic device 201 may monitor the geofence information.

In one embodiment, monitoring the geofence information may include at least one of monitoring whether the electronic device 201 remains in the geofence and monitoring whether the electronic device (e.g. electronic device 102 or 104) of a chatroom member remains in the geofence.

In one embodiment, the electronic device 201 may use the location measurement sensor (e.g. communication module 220 or GNSS module 227) to monitor whether the electronic device 201 enters or exits the configured geofence. The electronic device 201 may send a geofence entry or exit notification to the server (e.g. messenger server, or SNS server like the server 106).

In one embodiment, the electronic device 201 may receive information indicating whether the electronic device (e.g. electronic device 102 or 104) of a chatroom member has entered or exited the geofence from the server (e.g. messenger server, or SNS server like the server 106).

At step 1805, the processor 210 of the electronic device 201 may receive a message from the server.

At step 1807, the processor 210 of the electronic device 201 may use the location measurement sensor (e.g. communication module 220 or GNSS module 227) to determine whether the electronic device 201 has entered or exited the configured geofence.

Upon determining that the electronic device 201 has entered the geofence at step 1807, the procedure proceeds to step 1809.

At step 1809, as the electronic device 201 remains in the geofence, the processor 210 of the electronic device 201 may output the received message.

In one embodiment, when a message is received while the electronic device 201 remains in the geofence, the electronic device 201 may perform at least one of displaying the body of the received message on the display 260, outputting a sound alert indicating message reception through the speaker 282, and outputting a vibration notification indicating message reception through the motor 298.

Specifically, when the electronic device 201 remains in the geofence at step 1809, the electronic device 201 may display the body of the received message on the display 260.

When the electronic device 201 remains in the geofence at step 1809, the electronic device 201 may output a sound alert indicating message reception through the speaker 282.

When the electronic device 201 remains in the geofence at step 1809, the electronic device 201 may output a vibration notification indicating message reception through the motor 298.

Upon determining that the electronic device 201 has exited the geofence at step 1807, the procedure proceeds to step 1811.

At step 1811, as the electronic device 201 does not remain in the geofence, the processor 210 of the electronic device 201 may process the received message in a preset manner.

In one embodiment, the notification level when the electronic device 201 remains outside the geofence may be different from that when the electronic device 201 remains in the geofence.

For example, when a message is received while the electronic device 201 remains in the geofence, the electronic device 201 may output a notification for message reception by at least one of outputting sounds, displaying a badge image, and outputting vibrations. On the other hand, when a message is received while the electronic device 201 remains outside the geofence, the electronic device 201 may display a badge image indicating message reception.

In one embodiment, when the electronic device 201 remains in the geofence, the notification level may be set according to “do not disturb” mode.

In one embodiment, the manner to process a received message at step 1811 may be pre-configured by the user or may be automatically determined by the electronic device 201.

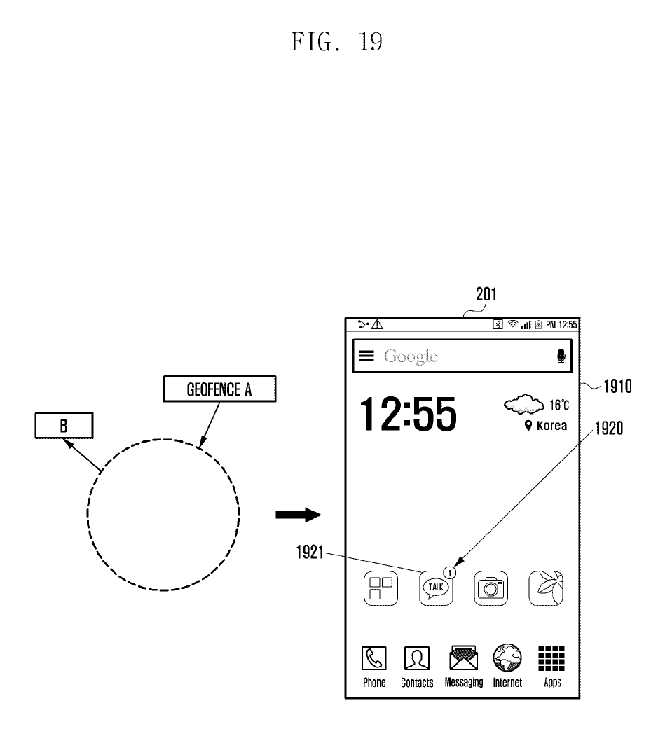

FIG. 19 illustrates messenger operation based on location information of the electronic device 201 according to various embodiments of the present disclosure.

The processor 210 of the electronic device 201 may create a chat room based on geofence information.

In one embodiment, when the electronic device 201 remains outside the configured geofence (e.g. geofence A), the notification level for a message received from another electronic device of a chatroom member via the server (e.g. messenger server, or SNS server like the server 106) may be lower in comparison to the notification level for a message received when the electronic device 201 remains in the configured geofence (e.g. geofence A). For example, when a message received from another electronic device of a chatroom member via the server while the electronic device 201 remains outside the configured geofence (e.g. geofence A), the electronic device 201 may output a badge image 1920 indicating message reception on the messenger application icon 1921 displayed on the home screen 1910.

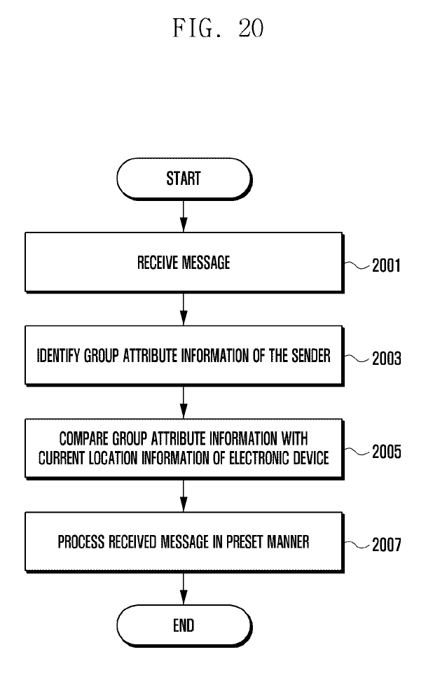

FIG. 20 illustrates a flowchart of a procedure for messenger operation based on location information of the electronic device 201 according to various embodiments of the present disclosure.

Referring to FIG. 20, after a chat room is created on the basis of geofence information, at step 2001, the processor 210 of the electronic device 201 may receive a message from a different chatroom member.

At step 2003, the processor 210 of the electronic device 201 may identify the group attribute information of the message sender.

In one embodiment, it is possible to configure a geofence on the basis of contact groups (e.g. company, family, or friend) in the contact list. Attribute information of the group of the sender may indicate a contact group. Group attribute information may include location information such as location information of the corresponding group.

For example, when each chatroom member has contact group information “company” as category information, the electronic device 201 or the server (e.g. messenger server, or SNS server like the server 106) may set geofence information to “company”.

At step 2005, the processor 210 of the electronic device 201 may compare the group attribute information of the message sender with the current location information of the electronic device 201.

At step 2007, the processor 210 of the electronic device 201 may process the received message in a preset manner according to the comparison result. For example, when the group attribute information is “company” and the current location information of the electronic device 201 is “company”, the electronic device 201 may output a notification for message reception by at least one of outputting sounds, displaying a badge image, and displaying information on the received message. When the group attribute information is “company” and the current location information of the electronic device 201 is not “company”, the electronic device 201 may output a notification for message reception in a manner different from that used when the electronic device 201 remains in the geofence.

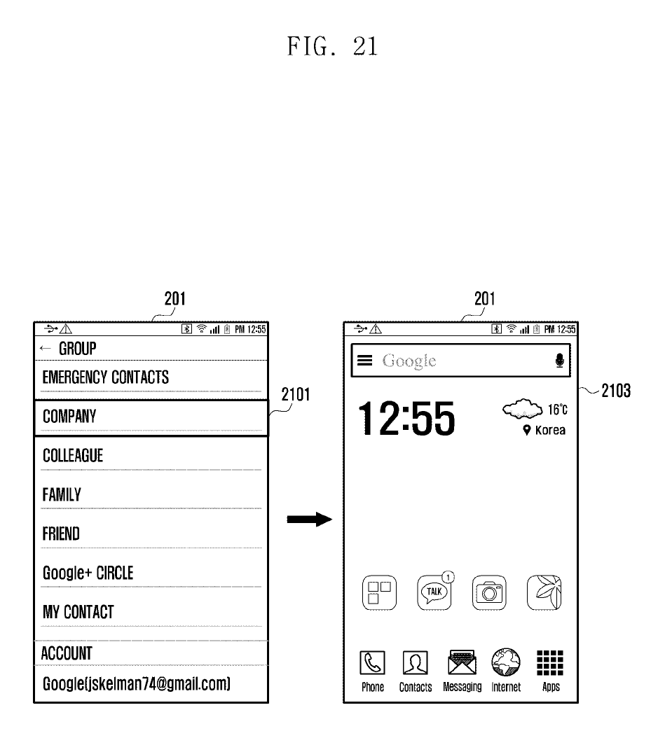

FIG. 21 illustrates messenger operation based on location information of the electronic device 201 according to various embodiments of the present disclosure.

In one embodiment, the electronic device 201 may process a received message in a preset manner according to the result of comparison between the group attribute information and the current location information of the electronic device 201. For example, when the group attribute information of the sender is “company” (as indicated by indicia 2101) and the current location information of the electronic device 201 is “company”, the electronic device 201 may output a notification for message reception by at least one of outputting sounds, displaying a badge image, and displaying information on the received message (as indicated by indicia 2103). When the group attribute information is “company” (as indicated by indicia 2101) and the current location information of the electronic device 201 is not “company”, the electronic device 201 may output a notification for message reception in a manner different from that used when the electronic device 201 remains in the geofence.

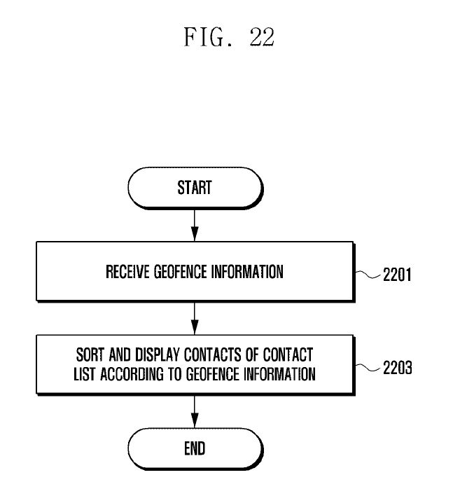

FIG. 22 illustrates a flowchart of a procedure for messenger operation based on location information of the electronic device 201 according to various embodiments of the present disclosure.

Referring to FIG. 22, at step 2201, the processor 210 of the electronic device 201 may use the communication module 220 to receive geofence information from the server (e.g. messenger server, or SNS server like the server 106).

At step 2203, the processor 210 of the electronic device 201 may sort contacts of the contact list according to the geofence information and display the sorted contacts. For example, the electronic device 201 may output the contacts of those members remaining in the geofence in a region and output the contacts of those members remaining outside the geofence in another region on the display 260.

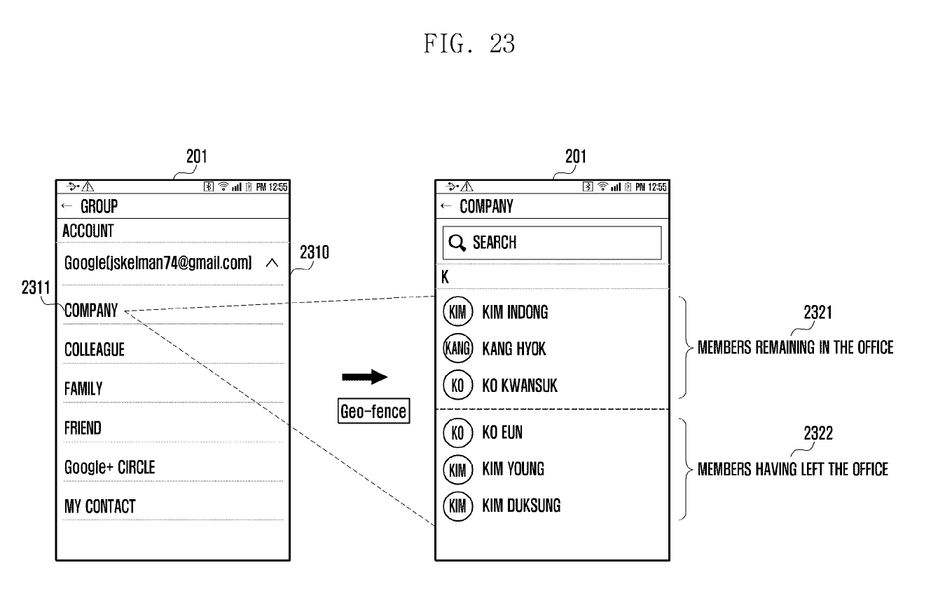

FIG. 23 illustrates messenger operation based on location information of the electronic device according to various embodiments of the present disclosure.

After a chat room is created on the basis of geofence information, the electronic device 201 may use the communication module 220 to receive the geofence information from the server (e.g. messenger server, or SNS server like the server 106). The geofence information may include updated geofence entry/exit status information of chatroom members.

In one embodiment, the electronic device 201 may sort contacts of the contact list according to the geofence information and display the sorted contacts. For instance, the electronic device 201 may output the contacts of those members remaining in the geofence in a region and output the contacts of those members remaining outside the geofence in another region on the display 260.

For example, when the geofence is configured around the company and contact group information (indicated by indicia 2310) is set to “company” (as indicated by indicia 2311) on the display 260, the electronic device 201 may separately output contacts of those members remaining in the geofence (indicia 2321) and contacts of those members remaining outside the geofence (indicia 2322) on the display 260. For example, shading may be used to distinguish between the contacts of those members remaining in the geofence (indicia 2321) and the contacts of those members remaining outside the geofence (indicia 2322).

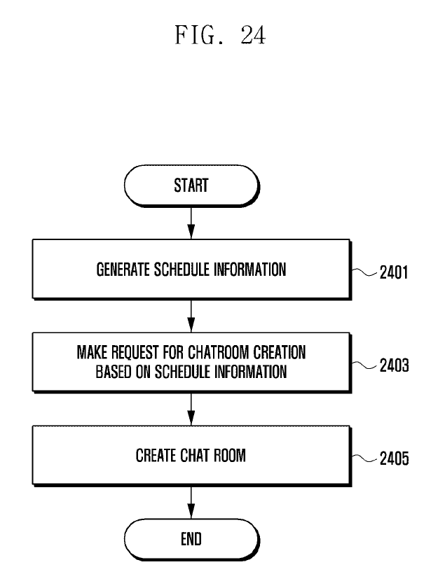

FIG. 24 illustrates a flowchart of a procedure for messenger operation based on location information of the electronic device according to various embodiments of the present disclosure.

Referring to FIG. 24, at step 2401, the processor 210 of the electronic device 201 may generate schedule information. The schedule information may include information regarding an event, date, place, and participants. The schedule information may be delivered to the context framework of the electronic device 201 via a schedule application (e.g. calendar application 381). The context framework may apply statistical analysis to the schedule application and deliver the statistical analysis result to the schedule application (e.g. calendar application 381). Upon reception of the statistical analysis result, the schedule application may send a request for chatroom creation to the messenger application according to the schedule information (event, date, place, and participants).

In various embodiments, the context framework may be a framework for analyzing contexts and inferring a meaning.

At step 2403, the processor 210 of the electronic device 201 may make a request for chatroom creation on the basis of the schedule information. For example, the schedule application (e.g. calendar application 381) may request the messenger application to create a chat room according to the schedule information (event, date, place, and participants) at some time ahead of the occurrence of the event. The messenger application may use the communication module 220 to send a chatroom creation request to the server (e.g. messenger server, or SNS server like the server 106). Upon reception of a chatroom creation request, the server may permit the messenger application installed in the electronic device 201 to create a chat room. In addition, the server may permit electronic devices of the participants contained in the schedule information to create a chat room.

At step 2405, the processor 210 of the electronic device 201 may create a chat room with participants contained in the schedule information.

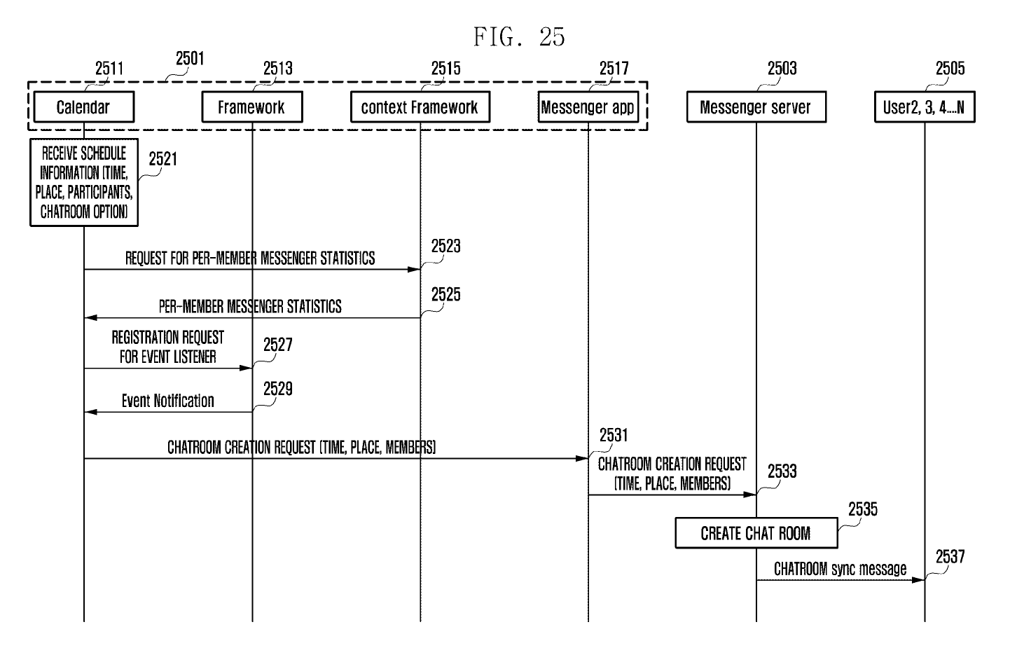

FIG. 25 illustrates a sequence diagram depicting signal flows between the server and electronic devices for messenger operation based on location information according to various embodiments of the present disclosure.

In FIG. 25, the electronic device 2501 (e.g. electronic device 201) may include a schedule application 2511, a framework 2513, a context framework 2515, and a messenger application 2517.

At step 2521, the electronic device 2501 may receive schedule information through the schedule application 2511. The schedule information may include information regarding an event, date, place, and participants.

At step 2523, the schedule application 2511 may send the context framework 2515 a request for per-member messenger statistics (messenger statistics for each participant in the schedule information).

At step 2525, the context framework 2515 may send per-member messenger statistics to the schedule application 2511.

Upon reception of per-member messenger statistics, at step 2527, the schedule application 2511 may send the framework 2513 a registration request for an event listener as to the schedule information. The event listener may monitor occurrence of the planned event indicated by the schedule information and invoke a corresponding handler application.

At step 2529, the framework 2513 may send an event notification to the schedule application 2511 upon arrival of the date or time indicated by the schedule information or at some time ahead thereof.

Upon reception of an event notification, at step 2531, the schedule application 2511 may send a chatroom creation request together with the schedule information to the messenger application 2517.

Upon reception of a chatroom creation request and the schedule information, at step 2533, the messenger application 2517 may forward the chatroom creation request and the schedule information to the server 2503 (e.g. messenger server, or SNS server like the server 106).

Upon reception of the chatroom creation request from the messenger application 2517, at step 2535, the server 2503 may create a chat room with electronic devices 2505 of the participants indicated by the schedule information (as members).

At step 2537, the server 2503 may send a chatroom synchronization message to the electronic devices 2505 of the participants to synchronize chatroom messages between the members.

In one embodiment, after creation of a chat room, the server 2503 may send a chatroom synchronization message to the electronic devices 2505 of the participants, so that the participants may view messages, of the chat room created by the user of the electronic device 2501, on their messenger windows.

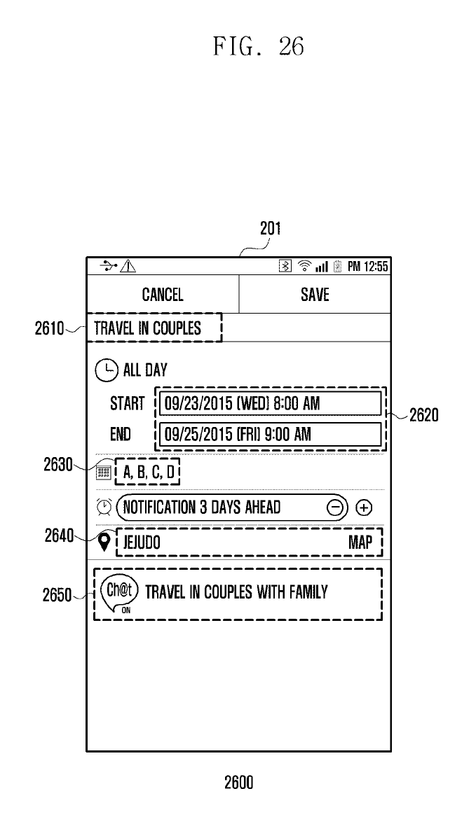

FIG. 26 illustrates a user interface window of the schedule application according to various embodiments of the present disclosure.

Referring to FIG. 26, when the schedule application is executed, the electronic device 201 may display a schedule application window 2600 on the display 260.

In one embodiment, the schedule application window 2600 may include fields or sections for title 2610, duration 2620, participants 2630, place 2640, and messenger option 2650. The title 2610 may be given by user input, may indicate the property of the scheduled event, and may be used as the name or title of a chat room to be created. The duration 2620 indicates the start and end of the event and may be used to determine the point in time for chatroom creation. The duration 2620 may be given by user input and may be used as the name or title of the chat room after the end of the event. The participants 2630 may be given by user input. When some contacts of the contact list are selected, the selected contacts may be displayed as participants in the schedule application window 2600. The place 2640 may be used to configure a geofence for chatroom creation. The place 2640 may be used to determine whether to create a chat room. The place 2640 may be given by user input and may be used as the name or title of the chat room after the end of the event. The messenger option 2650 may be used for determining whether to create a chat room and for selecting a messenger application. The messenger option 2650 may be given by user input. When a specific messenger application is frequently used by the participants, the messenger application may be automatically recommended through context framework statistics.

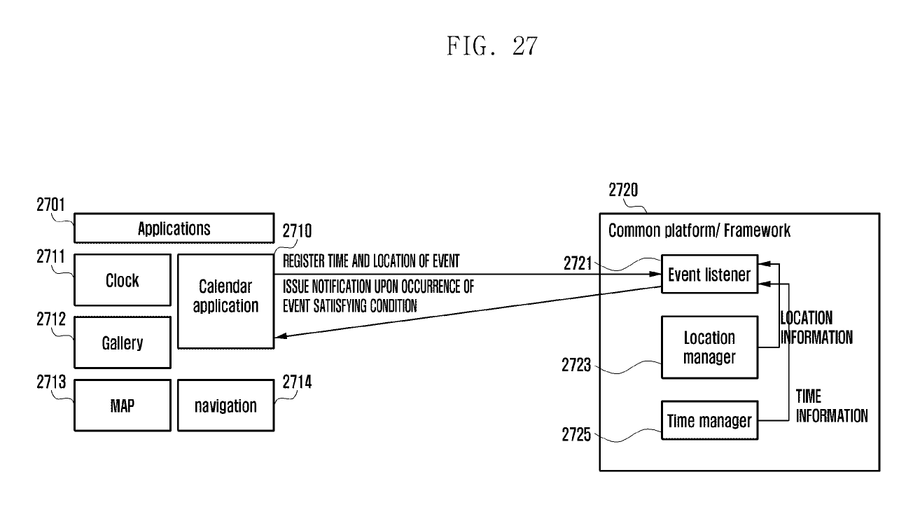

FIG. 27 illustrates monitoring of a chatroom creation condition on the basis of schedule information according to various embodiments of the present disclosure.

Referring to FIG. 27, the electronic device 201 may include applications 2701 such as calendar 2710, clock 2711, gallery 2712, map 2713, and navigation 2714.

In one embodiment, the calendar application 2710 (e.g. schedule) may register, as an event notification condition, the date (or time) and place (or location) of the schedule information at the event listener 2721 of the framework 2720.

When the place or time of the schedule information is reached, the location manager 2723 (e.g. location manager 350) or time manager 2725 of the framework 2720 may notify the event listener 2721 of condition satisfaction.

Upon reception of a condition satisfaction notification from the location manager 2723 or the time manager 2725, the event listener 2721 of the framework 2720 may send an event notification to the calendar application 2710.

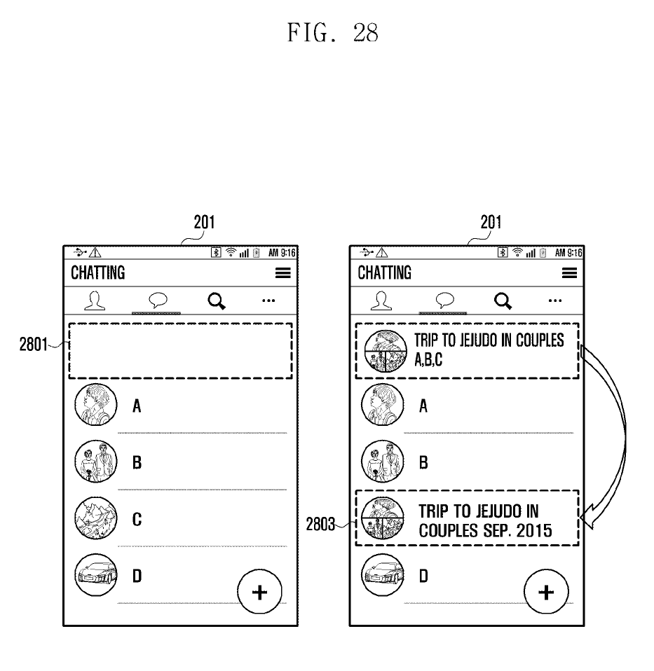

FIG. 28 illustrates screen representations for messenger operation based on location information according to various embodiments of the present disclosure.

Referring to FIG. 28, after a chat room is created according to the schedule information stored in the schedule application, when the planned event ends, the electronic device 201 may delete or hide the chat room as indicated by indicia 2801. Later, after the chat room is hidden, when the user revisits the same place or location, the electronic device 201 may display the hidden chat room again on the display 260.

In one embodiment, after a chat room is created according to the schedule information stored in the schedule application, when the planned event ends, the electronic device 201 may change the title of the chat room to past tense and move the chat room backwards in the display sequence as indicated by indicia 2803. After a chat room is created according to the schedule information stored in the schedule application, when the planned event ends, the electronic device 201 may change the title of the chat room to past tense on the basis of the indicated time and existing title.

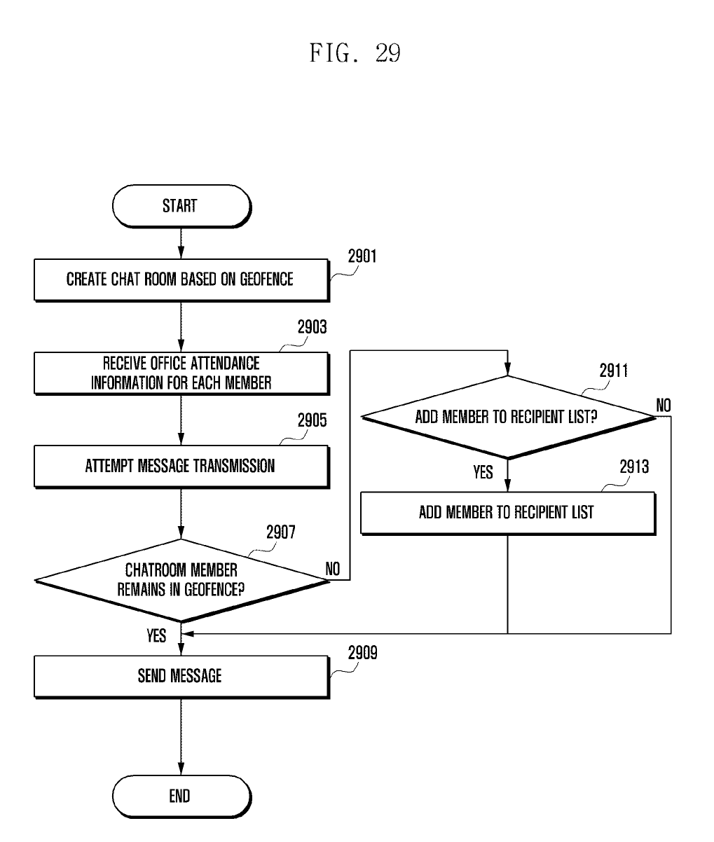

FIG. 29 illustrates a flowchart of a procedure for messenger operation based on location information of the electronic device 201 according to various embodiments of the present disclosure.

Referring to FIG. 29, at step 2901, the processor 210 of the electronic device 201 may create a chat room based on geofence information.

At step 2903, the processor 210 of the electronic device 201 may receive office attendance information for each chatroom member from the server (e.g. messenger server, or SNS server like the server 106).

At step 2905, the processor 210 of the electronic device 201 may attempt message transmission if message transmission is requested.

At step 2907, the processor 210 of the electronic device 201 may determine whether a chatroom member remains in the geofence on the basis of the received office attendance information.

Upon determining that a chatroom member remains in the geofence at step 2907, the procedure proceeds to step 2909.

At step 2909, the processor 210 of the electronic device 201 may use the communication module 220 to transmit a message.

Upon determining that no chatroom member remains in the geofence at step 2907, the procedure proceeds to step 2911.

At step 2911, the processor 210 of the electronic device 201 may determine whether to add a chatroom member remaining outside the geofence to the recipient list.

Upon determining to add a chatroom member remaining outside the geofence to the recipient list at step 2911, the procedure proceeds to step 2913.

At step 2913, the processor 210 of the electronic device 201 may add the chatroom member remaining outside the geofence to the recipient list. A message can be sent to the chatroom member newly added to the recipient list in addition to existing chatroom members in the recipient list.

Upon determining not to add a chatroom member remaining outside the geofence to the recipient list at step 2911, the procedure proceeds to step 2909.

At step 2909, the processor 210 of the electronic device 201 may send a message to chatroom members in the recipient list.

In the description, the word “module” refers to a software component, a hardware component, a firmware component or a combination thereof, which is capable of carrying out a function or an operation. “Module” may be used interchangeably with “unit”, “block”, “circuit” or the like. A module may be implemented mechanically or electronically. For example, a module having a specific function may be implemented using at least one of an application-specific integrated circuit (ASIC), a field-programmable gate array (FPGA) and a programmable-logic device (PLD).

In various embodiments, at least part of the apparatus (e.g. modules or functions) or the method (e.g. operations) can be implemented as instructions stored in a computer-readable storage medium (e.g. memory 130) in the form of a programming module. When the instructions are executed by one or more processors (e.g. processor 120), the processors can perform functions corresponding to the instructions. The computer-readable storage medium can be, for example, the memory 130.

The computer-readable storage medium can include magnetic media such as hard disk, floppy disk and magnetic tape, optical media such as Compact Disc Read Only Memory (CD-ROM) and Digital Versatile Disc (DVD), magneto-optical media such as floptical disk, and hardware devices specifically configured to store and execute program instructions (e.g., the programming module) such as ROM, RAM, and flash memory. Also, the program instructions can include not only machine code produced by a complier but also high-level language code executable by a computer using an interpreter. The above-stated hardware units can be implemented by one or more software modules for carrying out the operations of various embodiments of the present disclosure, and vice versa.

In various embodiments, the module or program module can include at least one of the aforementioned components, omit some components, or further include other components. The operations of modules, programming modules, or other components can be carried out in sequence, in parallel, in repetition, or in a heuristic manner. Also, some operations can be executed in a different order or omitted, or other operations can be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for messenger operation based on location information of an electronic device, the method comprising:
creating a chat room with two or more members based on geofence information, the geofence information corresponding to a geofence;
monitoring whether a chat room member enters or exits the geofence;
displaying a message input window for the chat room;
determining whether all the chat room members remain in the geofence; and
sending, when all chatroom members remain in the geofence, a message to electronic devices of the chat room members in response to a message transmission request.

2. The method of claim 1, further comprising:
displaying, when all chat room members do not remain in the geofence, a user interface window that separately presents information on those chat room members remaining in the geofence and information on those chat room members remaining outside the geofence, enables removal of a chat room member remaining outside the geofence from a recipient list, and enables addition of a chat room member remaining outside the geofence to the recipient list;
determining whether to add a chat room member remaining outside the geofence to the recipient list; and
sending, when a chat room member remaining outside the geofence is added to the recipient list, a message to electronic devices of chat room members in the recipient list.

3. The method of claim 2, further comprising sending, when the chat room member remaining outside the geofence is not added to the recipient list, a message to electronic devices of chat room members in the recipient list except for the chat room member remaining outside the geofence.

4. The method of claim 1, wherein creating a chat room with two or more members comprises:
receiving a request for significant location information from a messenger server;
sending, by electronic devices of chat room members, significant location information to the messenger server; and
receiving, after the messenger server determines the geofence and electronic devices of chat room members are synchronized with respect to the geofence information, the geofence information.

5. The method of claim 1, wherein creating a chat room with two or more members comprises:
displaying, after chat room creation, a map image on the display; and
configuring a geofence on the map image according to user input.

6. The method of claim 1, further comprising:
receiving a message from a messenger server;
notifying, when the electronic device remains in the geofence, a user of message reception using a first notification scheme; and
notifying, when the electronic device remains outside the geofence, the user of message reception using a second notification scheme.

7. The method of claim 1, further comprising:
receiving a message from a messenger server;
identifying group location attribute information of a message sender;
comparing the group location attribute information with current location information of the electronic device; and
notifying a user of message reception in a preset manner according to a result of the comparison.

8. The method of claim 1, further comprising:
sorting contacts of a contact list according to the geofence information; and
displaying the sorted contacts.

9. The method of claim 1, further comprising:
generating schedule information; and
creating the chat room when a time or location indicated by the schedule information is reached.

10. The method of claim 9, wherein the schedule information comprises information regarding at least one of a planned event, a title thereof, a duration thereof, a place thereof, participants, or a messenger option.

11. An electronic device comprising:
a location measurement sensor;
a communication module;
a display including a touch panel; and
a processor,
wherein the processor is configured to:
create a chat room with two or more members based on geofence information, the geofence information corresponding to a geofence,
monitor whether a chat room member enters or exits the geofence,
control the display to display a message input window for the chat room,
determine whether all the chat room members remain in the geofence, and
control, when all chat room members remain in the geofence, the communication module to send a message to electronic devices of the chat room members in response to a message transmission request.

12. The electronic device of claim 11, wherein, when all chat room members do not remain in the geofence, the processor is configured to:
control the display to display a user interface window that separately presents information on those chat room members remaining in the geofence and information on those chat room members remaining outside the geofence, enables removal of a chat room member remaining outside the geofence from a recipient list, and enables addition of a chat room member remaining outside the geofence to the recipient list;
determine whether to add a chat room member remaining outside the geofence to the recipient list; and
control, when a chat room member remaining outside the geofence is added to the recipient list, the communication module to send a message to electronic devices of chat room members in the recipient list.

13. The electronic device of claim 12, wherein, when the chat room member remaining outside the geofence is not added to the recipient list, the processor is configured to control the communication module to send a message to electronic devices of chat room members in the recipient list except for the chat room member remaining outside the geofence.

14. The electronic device of claim 11, wherein the processor is configured to:
control the communication module to receive a request for significant location information from a messenger server;
control the communication module to send significant location information to the messenger server; and
control, after the messenger server determines the geofence and electronic devices of chatroom members are synchronized with respect to the geofence information, the communication module to receive the geofence information from the messenger server.

15. The electronic device of claim 11, wherein, when the chat room is created, the processor is configured to:
control the display to display a map image; and
configure a geofence on the map image according to user input.

16. The electronic device of claim 11, wherein, when a message is received from a messenger server, the processor is configured to:
notify, when the electronic device remains in the geofence, a user of message reception using a first notification scheme, and
notify, when the electronic device remains outside the geofence, the user of message reception using a second notification scheme.

17. The electronic device of claim 11, wherein the processor is further configured to:
receive a message from a messenger server;
identify group location attribute information of a message sender;
compare the group location attribute information with current location information of the electronic device; and
notify a user of message reception in a preset manner according to a result of the comparison.

18. The electronic device of claim 11, wherein the processor is further configured to:
sort contacts of a contact list according to the geofence information; and
display the sorted contacts on the display.

19. The electronic device of claim 11, wherein the processor is further configured to:
generate schedule information; and
create the chat room when a time or location indicated by the schedule information is reached.

20. The electronic device of claim 19, wherein the schedule information comprises at least one of information regarding at least one of a planned event, a title thereof, a duration thereof, a place thereof, participants, or a messenger option.
